(19) United States
(12) Patent Application Publication
(10) Pub. No.: US 2025/0051691 A1
(43) Pub. Date: Feb. 13, 2025

(54) DISSOLVABLE CAR CLEANING SHEET

(71) Applicant: SHEETS LAUNDRY CLUB INC., MOORESVILLE, NC (US)

(72) Inventor: MARIO TREMBLAY, ST. PETERSBURG, FL (US)

(21) Appl. No.: 18/911,204

(22) Filed: Oct. 9, 2024

Related U.S. Application Data
(60) Provisional application No. 63/531,582, filed on Aug. 9, 2023.

(51) Int. Cl. C11D 3/37; B60S 3/00; B60S 3/04; C11D 3/00; C11D 3/04; C11D 3/06; C11D 3/20; C11D 3/395; C11D 3/50; C11D 11/00; C11D 17/00; C11D 17/04

(52) U.S. Cl. CPC C11D 3/3753; B60S 3/008; B60S 3/045; C11D 3/001; C11D 3/044; C11D 3/06; C11D 3/201; C11D 3/2068; C11D 3/2072; C11D 3/3707; C11D 3/373; C11D 3/395; C11D 3/505; C11D 11/00; C11D 17/003; C11D 17/044

(57) ABSTRACT

A flexible Car Cleaning Sheet (CCS) based on a combination of polyvinyl alcohol, a cleaning composition, perfumes and/or fragrances, binding agents, thickening agents, polymers such as starch, cellulose, and other ingredients that when the CCS is dried, it produces a composition that remains solid and flexible, and then dissolves completely in water. Once the ingredients for the composition of said CCS is mixed in proper ratios, it forms a liquid-based composition that is poured onto a drying plate and/or extruded onto a roll that is later cut to size. After the flexible and dissolvable CCS is produced, it can be used in a wide range of applications. When wet or when in contact with water, said CCS composition dissolves completely and releases all of its active ingredients which may include surfactants, chelating agents, dyes, fabric softeners, bleaching agents, enzymes, perfumes, fragrances, or perfume micro capsules, or a combination thereof.

### FIELD OF THE INVENTION

This invention relates to a Car Cleaning Sheet and specifically a dissolvable Car Cleaning Sheet (CCS) containing polyvinyl alcohol and various car cleaning compositions and methods for a wide range of applications.

### BACKGROUND OF THE INVENTION

Conventional car cleaning equipment typically consists of a wide range of cleaning, conditioning, abrasive materials, waxes and in the form of liquid and powders. In some cases, there are non-dissolvable sheets that can be found in a sheet form that have some of the cleaning ingredients incorporated into the non-dissolvable sheet. These sheets can be used as is or can be wetted to deliver the car cleaning benefit that results in one or more of the car cleaning steps for the interior and/or the exterior of the vehicle.

The composition on these non-dissolvable sheets can release product onto the vehicle during the washing process and either be wiped off or leave behind some residual ingredients onto the various car surfaces. One drawback with using non-dissolvable car cleaning sheets, is that once they have been used, there is still some composition present in the sheet and the used sheet must be disposed of. Non-dissolvable sheets are typically stacked in a package or processed onto a roll where each sheet can be separated to provide the car cleaning benefit desired.

Car cleaning and detailing is often done using a wash rag, a microfiber cloth, a wash mit, a brush, a toothbrush, cotton swabs, toothpaste and a wide range of cleaning and conditioning products that are either added separately or in a combination of these product. Car cleaning is also achieved using a wide range of non-dissolvable cleaning sheet. Accordingly there remains a need for a car cleaning sheet that doesn't require any of these many types of car cleaning ingredients added separately or added together.

### SUMMARY OF THE INVENTION

A flexible car cleaning sheet based on a combination of polyvinyl alcohol, a cleaning composition, and a composition of perfume and/or fragrances, and ingredients consisting of thickening agents, polymers such as starch, cellulose, and other ingredients that when dried, produce a composition that remains solid and flexible when dried, and produces a CCS that remains solid and flexible when dry and then dissolves completely in water. Once the composition is mixed in proper ratios, it forms a liquid that is poured onto a drying plate and after drying results in a flexible CCS that can be used in a wide range of applications. When wet or when in contact with water, said composition dissolves completely and releases all of its active ingredients which may include surfactants, chelating agents, dyes, fabric softeners, bleaching agents, enzymes, perfumes, fragrances and perfume microcapsules.

### BRIEF DESCRIPTION OF THE FIGURES

FIG. 1 is an illustration of a non-limiting embodiment of a homogenizer assembly, component feeds, and drum dryer assembly according to the invention.

FIG. 2 is an illustration of a non-limiting embodiment in a perspective view showing the dimensions of a water dissolvable PVA sheet according to the invention.

FIG. 3 is a photo representation of a top view of a non-limiting embodiment showing ruler dimensions of a water dissolvable PVA sheet according to the invention.

FIG. 4 is a photo representation of a side view of a non-limiting embodiment showing ruler dimensions of a water dissolvable PVA sheet according to the invention.

FIG. 5 is a flow chart illustration of a non-limiting embodiment of a method of manufacturing a water dissolvable PVA sheet using a homogenizer assembly, a supply for component feeds, and a drum dryer assembly according to the invention.

FIG. 6 is a perspective illustration of a non-limiting embodiment of a drum dryer assembly showing a drum drive and a sheet winding assembly according to the invention.

FIG. 7 is a perspective illustration of a non-limiting embodiment of a drum dryer assembly showing a drum drive according to the invention.

FIG. 8 is a perspective illustration of a non-limiting embodiment of a drum dryer assembly showing a drum drive and steam inlet according to the invention.

FIG. 9 is an side view illustration of a non-limiting embodiment of a drum dryer assembly showing a drum drive, a steam inlet, and applicator roller tray according to the invention.

FIG. 10 is an end view illustration of a non-limiting embodiment of a drum dryer assembly showing a drum drive, motor, and sheet winding assembly according to the invention.

FIG. 11 is a top view illustration of a non-limiting embodiment of a drum dryer assembly showing a drum drive, motor, and sheet winding assembly according to the invention.

FIG. 12 is a cut-away view illustration of a non-limiting embodiment of a drum dryer assembly showing a drum drive, motor, dryer drum, roller tray, roller, and steam delivery conduit according to the invention.

FIG. 13 is an perspective illustration of a non-limiting embodiment of an applicator roller tray, and roller assembly according to the invention.

FIG. 14 is an perspective illustration of a non-limiting embodiment of an applicator roller tray, and roller assembly according to the invention.

FIG. 15 is an perspective illustration of a non-limiting embodiment of a tray raising/lowering assembly according to the invention.

FIG. 16 is a side view illustration of a non-limiting embodiment of a tray raising/lowering assembly according to the invention.

FIG. 17 is an perspective illustration of a non-limiting embodiment of an applicator tray, roller, and tray raising/lowering assembly according to the invention.

FIG. 18 is an perspective illustration of a non-limiting embodiment of a (sheet) feed leveling roller assembly according to the invention.

FIG. 19 is a detail illustration of a non-limiting embodiment of a leveling adjustment mechanism for the (sheet) feed leveling roller assembly according to the invention.

### DETAILED DESCRIPTION OF THE INVENTION

In a preferred embodiment, the invention provides a process for manufacturing a water dissolvable car cleaning sheet, comprising: (i) homogenizing at 85° C. in a high shear mixer an aqueous solution of polyvinyl alcohol, a surfactant, a builder, a binding agent, a chelating agent, and a car surface treatment ingredient, to form a PVA homogenate; (ii) casting the PVA homogenate as a wet film onto a heated stainless steel roller drum and dehydrating using steam heat to obtain a PVA film 1.5-2.0 mm thick; and (iii) optionally trimming the PVA film to form a single sheet size (2-5″ wide and 3-8″ length) of a water dissolvable car cleaning sheet.

In another preferred embodiment, the invention provides a water dissolvable car cleaning sheet comprising polyvinyl alcohol 3-25%, a surfactant 5-50%, a builder 0.1-5%, a binding agent 0.1-5%, a chelating agent 0.1-5%, a car surface treatment ingredient 0.1-5%, and water 3-50%, by mass ratio, in a PVA film 1.5-2.0 mm thick; trimmed to form a single sheet size 2-5″ wide and 3-8″ length of a water dissolvable car cleaning sheet.

Any of the preferred embodiments herein may include wherein the car surface treatment is a car interior cleaning treatment comprising sodium triphosphate, 2-butoxyethanol, and ethyl alcohol.

Any of the preferred embodiments herein may include wherein the car surface treatment is a car exterior cleaning treatment comprising dimethicone, citral, polyethylene glycol (PEG-9), and sodium hydroxide.

Any of the preferred embodiments herein may include wherein said binding agent is selected from the group consisting of: resin, wax, gum, accroides, candelilla, guar gum, gum Arabic, shellac, tragacanth, and a mixture of one or more thereof.

Any of the preferred embodiments herein may include wherein the builder is selected from the group consisting of: citric acid, citrate, sodium carbonate, sodium silicate, polyphosphates, and a mixture of one or more thereof.

Any of the preferred embodiments herein may include wherein the chelant is selected from the group consisting of EDTA, MGDA, DTPA, sodium gluconate or a mixture of one or more thereof.

Any of the preferred embodiments herein may include wherein the aqueous solution includes a residue remover.

Any of the preferred embodiments herein may include wherein said aqueous solution includes a water dissolvable co-polymer selected from the group consisting of ethylene oxide co-polymer, propylene oxide co-polymer, and a combination ethylene oxide-propylene oxide co-polymer.

Any of the preferred embodiments herein may include wherein the water dissolvable car cleaning sheet is 3-10% water by weight.

Any of the preferred embodiments herein may include wherein the water dissolvable car cleaning sheet comprises 0.5% to 12% of a copolymer by weight.

Any of the preferred embodiments herein may include wherein the water dissolvable car cleaning sheet comprises 5% to 50% surfactant by weight, wherein the surfactant is selected from the group consisting of an anionic surfactant, a cationic surfactant, a non-ionic surfactant, and an amphoteric surfactant.

Any of the preferred embodiments herein may include wherein the chelating agent is selected from the group of EDTA, MGDA, DTPA, zeolite, phosphonate, citric acid, citrate, and a mixture thereof.

Any of the preferred embodiments herein may include the step of applying a water-based fragrance 0.3% by weight to the water dissolvable car cleaning sheet using a sandwich roller.

Any of the preferred embodiments herein may include wherein the aqueous solution includes a bleaching agent is selected from the group consisting of calcium hypochlorite, sodium hypochlorite, sodium percarbonate, sodium perborate, sodium persulfate, tetrasodium pyrophosphate, urea peroxide and a combination thereof.

Any of the preferred embodiments herein may include wherein the aqueous solution includes a fabric softener agent is selected from the group of quaternary ammonium cations/salts, cetrimonium bromide, quaternary ammonium chloride, polydimethylsiloxane, silicone, and a mixture thereof.

Any of the preferred embodiments herein may include wherein water dissolvable car cleaning sheet is a hydrogel comprising at least 50% water by weight.

Any of the preferred embodiments herein may include wherein the anionic surfactant is selected from a group consisting of sulfate, sulfonate, sodium dodecylbenzene sulfonate, sodium laureth sulfate, and a combination thereof.

Any of the preferred embodiments herein may include wherein the aqueous solution includes an anti-beading compound.

Any of the preferred embodiments herein may include wherein the aqueous solution includes a cleaning grit selected from the group consisting of silicate, diatomaceous earth, silica particles, quartz particles, calcite particles, rottenstone, whiting, pumice, volcanic ash, marble particles, feldspar particles, copper particles, polymer particles, and metal particles.

Any of the preferred embodiments herein may include wherein the sheet is mounted on a cleaning mitt, cleaning glove, or cleaning sponge.

Any of the non-limiting embodiments herein may include wherein the sheet is manufactured as a laminate, or wherein the laminate comprises biaxial layers, or wherein the laminate layers are oriented as a weave, mesh, twill, satin or basket pattern.

Any of the non-limiting embodiments herein may include wherein the sheet is reinforced with a plurality of fibers selected from water dissolvable polymer fibers, wool fibers, cotton fibers, or hemp fibers, or wherein the fibers are oriented as a weave, mesh, twill, satin or basket.

Any of the non-limiting embodiments herein may include wherein the sheet is a continuous sheet having a perforated weakened tear-line to provide separate individual sheets, or wherein the sheet is mounted on a cleaning mitt, cleaning glove, or cleaning sponge.

Any of the non-limiting embodiments herein may include wherein sheet is a hydrogel of polyvinyl alcohol, polysaccharide, or gelatin.

Any of the non-limiting embodiments herein may include a water-repellent beading ingredient comprising a hydroxy-terminated polydimethylsiloxane in acetone and water.

In another preferred embodiment, the invention provides a method for producing a water dissolvable car cleaning sheet, the steps comprising: (i) dissolving 5000 parts of polyvinyl alcohol in 20000 parts of water; (ii) mixing at 70° C. 2000 parts binder, 10 parts emulsifier, 40 parts of softening agent and 5 parts of silicone oil to the polyvinyl alcohol solution; (iii) applying the mixture to a substrate form at a depth of 50-100 μm and drying at a temperature of 120° C. to form a polyvinyl alcohol film; (iv) surface treating the polyvinyl alcohol film with a cleaning mixture to form a cleaning film, the cleaning mixture comprising a surfactant 1-5%, a builder 0.1-5%, a binding agent 0.1-5%, a chelating agent 0.1-5%, and a car surface treatment ingredient; (v) layering the cleaning film to form a cleaning sheet having a depth from 750-7500 um (micrometers), and optionally trimming and rolling to obtain a finished cleaning sheet.

Any of the non-limiting methods herein may include the step of including one or more layers of a hydrogel made from polyvinyl alcohol, polysaccharide, or gelatin, the hydrogel made by a process selected from reacting with a cross-linking agent (glutaraldehyde), applying a freeze-thaw cycle, or annealing.

There are a wide range of compositions that can be used to develop a CCS that can be used to clean any of the exterior and/or interior of the car surfaces. In order to deliver the best possible car cleaning results, a single dissolvable PVA film sheet may be produced or a series of laminated dissolvable PVA film sheets may be developed to incorporate all of the desirable car cleaning tasks using said CCS composition. By using a CCS composition that is made of two or more sheets that overlap each other, a series of unique car cleaning benefits that can be first delivered with the first layer of the CCS composition and a secondary benefit can be achieved as the first layer of the CCS dissolves and then exposes the composition of the second layer to perform a different cleaning task than the first layer was designed to deliver. A third and perhaps even a fourth layer may be used to deliver a unique set of sequential car cleaning tasks that couldn't be achieved with a single layered sheet of said CCS composition.

One of the most common ingredients used for car cleaning and detailing is surfactant. Some of these surfactants include sodium Lauryl Sulfates, Linear Alkyl Benzene Sulfonic Acid, Sodium Lauryl Ether Sulfate, Coco Diethanolamine, Alkylpolyglucosides, Amine Oxides, and Betaines. Synergetic compositions of surfactants are sought to maximize foam and cleaning performance while minimizing the total amount of the overall surfactant fraction in the CCS. Other surface cleaners, all-purpose cleaners, car wash products and hand soap composition can be incorporated into the PVA substrate of the CCS to deliver maximum cleaning with or without the addition of water or other solvents. The total range of surfactant composition in the CCS ranges from approximately 0.1% to more than approximately 35%, and preferably 3% to 25% and more preferably 5% to 20% in the CCS composition. The surfactants are incorporated into the PVA film and can be released as the PVA film dissolves. The CCS can be used directly onto the car surface or combined with the addition of water or other solvents to activate the surfactants in the CCS.

Additionally, the CCS can be used after the car has been cleaned and used while the car is drying or is fully dried. In this step, the CCS can deliver different attributes as a conditioner. For this particular benefit, various ingredients such as cationic surfactants, various polymers and additional deposition from specific binding agents can collaborate towards the conditioning or treatment of the car surface that is targeted for said benefit such as fabric conditioning or exterior car surface conditioning such as urethane coating to deliver residual shine and protection from the external elements including but not limited to ingredients such as sun, oxidation, oil, dirt or a combination thereof. Additionally, the CCS can be used to protect the external surface of the car and can consist of waxes, clear coat, paint sealant, or any other external treatment designed to protect the external surface of the car.

Some example applications include adding the fibrous matrix to the CCS to further add some form of mild abrasion to deliver buffing benefit to remove oxidative layers or remove small scratches on the paint. In some forms, the CCS may include the composition of small particle size of silica, alumina, calcified kaolin, hydrous kaolin, calcified alumina, calcified silica, Wollastonite, Clay bar, or a combination thereof. The abrasion from the smaller particles should be followed up with a CCS composition that consists of a step that will prevent exposure of the external car surface, once the treatment has been completed, and a protective coating should be applied to further protect the car surface from further damage.

The present invention relates to a composition for forming fibers or forming a film of car cleaning composition. The CCS fiber may include a PVA composition and may be combined with a wide range of ingredients to deliver a wide range of consumer benefits. In yet another form, the present invention relates to a CCS that is fabricated from car cleaning fibers or extruded from car cleaning filaments that results in a woven or non-woven substrate depending on the targeted application.

The described invention is based on a flexible poly-vinyl alcohol (PVA) and comprises several other components that are designed to create a consumer product that delivers car cleaning benefits in a wide range of applications. Said composition of the CCS may also be based on various methods to produce a CCS with a broad range of additional properties, either independently into a series of different CCS or via a combination of various properties that are incorporated into a single CCS that can be used to clean various car surfaces. The resulting CCS can be used to cover all the existing car cleaning applications today and even additional less typical properties such any of the existing external and internal car cleaning applications. This may be achieved via leaving a unique shine and protection of the car surface against the sun, oxidation, greasy residues, oily residue, clear coating, glass cleaning, glass protection, or a combination thereof. The CCS can essentially replace all the individual products that are currently sold on the market today in wet or dry forms. The CCS may be added to a bucket of water to wash the car surfaces or used directly to clean the exterior, or the interior or a combination thereof. The CCS may have a single layer or composed of a series of layers that can deliver sequential treatment that would otherwise require a multitude of different products rather than a single CCS to deliver the same or even better final car cleaning benefits.

This invention provides a convenient and cost-effective method for delivering car cleaning and detailing using a completely new form consisting of a dissolvable sheet. The car cleaning and detailing ingredients are formed into fibers that may be inter-connected into a fibrous matrix or simply dried into a film with different aesthetics, size and many other properties depending on the composition and purpose. The fibrous matrix of the car cleaning and detailing composition is made to be used as-is or can be activated when water or some other form of liquid is added to the CCS to form a car cleaning and detailing composition. Similar benefit can be achieved with a film like substrate as compared to that of a fiber like composition. Some examples include additional car conditioning materials and/or perfume and fragrance composition to further increase the benefit of the PVA based conditioning and scent delivery system.

For car cleaning and detailing a CCS is a preferred form as it can deliver any of the car cleaning objectives. The car cleaning checklist for the exterior consists of a wide range of potential tasks depending on the surface for which the CCS is formulated. On painted surfaces the use can consist of washing the surface, removing bug and tar, oxidation removal, polish, protect, wax or seal that paint surface. For wheels, the CCS can wash the wheels, apply a protective coating, clean the wheel wells, and clean the brake calipers. On tires, the CCS can clean rubber and dress the tires. For window and glass, the CCS can clean the windshield, sunroof, side mirror, passenger windows, headlights, and taillights. For trim and molding, the CCS can clean the front bumper, the splash guards, the front grill and the rocker panels. Other miscellaneous applications for the CCS consist of cleaning the tailpipe, license plate, door jambs and gas tank plate.

For car cleaning and detailing a CCS is also a preferred form as it can deliver any of the interior car cleaning parts. On carpets and upholstery, the CCS can clean the floor mats, and the carpet. On dashboards, CCS can clean the dashboard, console area, passenger trim pieces, steering wheel, knobs, vents, glovebox, and set levers. On leather the CCS can clean and condition the leather. On windows and glass, the CCS can clean the windshield, sunroof, passenger windows, and console. On trunks, the CCS can clean the interior, the rain gutter, and the trunk lid.

In another aspect, the present invention relates to a method of making a film containing a water soluble composition, optionally made from polyvinyl alcohol (PVA), which is processed and may be extruded to produce filaments or fibers by converting the filaments and/or fibers and/or nonwoven webs into films. In another embodiment, the PVA is casted and formed into a film.

Casting processes for making films, particularly water-soluble films, and/or films comprising water-soluble film forming materials (eg, polyvinyl alcohol) are known in the art. Such casting processes use a solvent and a solution of a film-forming material such as polyvinyl alcohol, which is deposited on and/or flowed over a casting surface such as a metal wheel, roller or belt. The solvent is then removed from the solution, for example by drying. Once the solvent is removed from the solution, a film formed from the filament forming material remains on the casting surface. The casting process for making films is known to be very time intensive since the solvent needs to be removed by drying.

Non-water soluble films and/or non-water soluble non-water soluble filament forming materials such as polypropylene, polyethylene, and thermotropic polymers (i.e., polymers that form liquid crystal melts) are, for example, water insoluble. Filaments of filament forming material have been made by spinning a web and then pressing the resulting web with heat into a film (often a porous film). However, such water-insoluble films and/or films containing water-insoluble filament forming materials are not suitable for uses and/or products that require water-soluble films.

Accordingly, films, particularly polar solvent soluble (e.g., water soluble) films, and/or polar solvent soluble filament forming materials, and/or difficulties of conventional film casting methods (specifically, solvents and film forming materials, and/or There is a need for a method of making a film comprising a water soluble filament forming material that avoids the fact that a film made from a casting solution containing a filament forming material is made at a low rate.

The present invention creates a film, for example a polar solvent soluble film and/or a film containing a polar solvent soluble filament forming material, by converting a nonwoven web containing filaments and/or fibers comprising a polar solvent soluble filament forming material into a film. By satisfying the above requirements by providing a process to do so.

In one embodiment of the present invention,
a. Providing a nonwoven web comprising a plurality of filaments, the plurality of filaments comprising a polar solvent soluble filament forming material;
b. Converting the nonwoven web to a film, and a process for making a film from the nonwoven web is provided.

In another embodiment of the invention, a film made by the process according to the invention is provided.

Accordingly, the present invention provides a process for making a film, a film made by such a process, and a unit volume product comprising such a film.

### Definitions

As used herein, “filament” means an elongated microparticle having a length that greatly exceeds its diameter, ie, a ratio of length to diameter of at least about 10.

The filaments of the present invention can be spun from the filament forming composition via suitable spinning process operations, such as melt blowing and/or spun bonding.

The filaments of the present invention may be single component and/or multicomponent. For example, the filament may comprise a bicomponent filament. The bicomponent filament may be in any form such as side-by-side, core and sheath, or sea-island type.

The filaments of the present invention are 2 inches or more, and 3 inches or more, and 4 inches or more, and 6 inches or more in length.

As used herein, filaments are typically considered continuous or essentially nearly continuous. Filaments are relatively longer than fibers. Non-limiting examples of filaments include meltblown and/or spunbond filaments.

As used herein, one or more fibers can be formed from the filaments of the present invention so that the filaments are cut to shorter lengths (e.g., less than 2 inches in length). Thus, in one embodiment, the present invention also comprises fibers comprising fibers made from the filaments of the present invention, such as one or more filament forming materials, and optionally one or more additives such as active agents. Including. Accordingly, references herein to the filaments of the present invention include fibers made from such filaments, unless otherwise noted. Fibers are typically considered discontinuous in nature relative to filaments that are considered to be essentially continuous.

As used herein, “filament forming composition” means a composition suitable for making the filaments of the present invention, such as by melt blowing and/or spunbonding. Filament-forming compositions comprise one or more filament-forming materials that exhibit properties that make them suitable for spinning into filaments. In one example, the filament forming material comprises a polymer. In addition to the one or more filament forming materials, the filament forming composition may include one or more additives, such as one or more active agents. Furthermore, the filament-forming composition may comprise one or more polar solvents, such as water, in which one or more, for example all filament-forming materials and/or one or more, for example all active agents, which are further dissolved or dispersed or a combination thereof.

As used herein, the filaments of the present invention are made from the filament-forming composition of the present invention has one or more additives, such as one or more active agents. The coating is such that it can be present in the filament rather than on the filament. The total concentration of filament forming material, and the total concentration of active agent present in the filament forming composition may be any suitable amount, as long as the filaments of the present invention are made therefrom.

As used herein, one or more additives, such as an active agent, may be present in the filament and one or more additional additives, such as an active agent, may be present on the surface of the filament. In other embodiments, the filaments of the present invention may include one or more additives, such as an active agent, which are present in the filament when first made, but are subject to the conditions of the intended use of the filament, further resulting in a bloom on the surface of the filaments before and/or when exposed to air or other external conditions.

As used herein, “filament-forming material” means a material such as a polymer or monomer that can produce a polymer that exhibits properties suitable for making filaments. In one example, the filament-forming material includes one or more substituted polymers, such as anionic, cationic, zwitterionic, and/or nonionic polymers. In other examples, the polymer may comprise a hydroxyl polymer, such as polyvinyl alcohol (“PVA”), and/or a polysaccharide, such as starch, and/or a starch derivative, such as ethoxylated starch, and/or acid diluted starch. In another example, the polymer may include polyethylene and/or terephthalate. In yet another embodiment, the filament forming material is a polar solvent soluble material.

As used herein, “additive” means any material that is present in the filaments of the invention and is not a filament forming material. In one example, the additive includes an active agent. In other embodiments, the additive includes a processing aid. In yet another embodiment, the additive includes a filler. In one embodiment, the additive is present in the filament, and the absence of it in the filament does not cause the filament to lose its filament structure (i.e., the absence of it causes the filament to be in its solid form. Including any material) that will not lose. In other embodiments, the additive, e.g., the active agent, includes a non-polymeric material.

As used herein, the additive includes a plasticizer for the filament. Non-limiting examples of suitable plasticizers of the present invention include polyols, copolyols, polycarboxylic acids, polyesters, and dimethicone copolyols. Examples of useful polyols include glycerin, diglycerin, propylene glycol, ethylene glycol, butylene glycol, pentylene glycol, cyclohexanedimethanol, hexanediol, 2,2,4-trimethylpentane-1,3-diol, polyethylene glycol (m.w. 200-800), sugar alcohols such as pentaerythritol, sorbitol, mannitol, lactitol and other mono- and polyhydric low molecular weight alcohols (eg C2-C8 alcohols); mono, di- and oligosaccharides such as fructose, Examples include, but are not limited to, glucose, sucrose, maltose, lactose, and higher fructose corn syrup solids, and dextrin, and ascorbic acid. In yet another example, the plasticizer includes glycerin and/or propylene glycol, and/or a glycerol derivative, such as propoxylated glycerol. In yet another embodiment, the plasticizer is selected from the group consisting of glycerin, ethylene glycol, polyethylene glycol, propylene glycol, glycidol, urea, sorbitol, xylitol, maltitol, saccharides, ethylene bisformamide, amino acids, and mixtures thereof. Is done.

As used herein, the additive includes a crosslinking agent suitable for crosslinking one or more filament-forming materials present in the filaments of the present invention. In one example, the cross-linking agent includes a cross-linking agent that can cross-link the hydroxyl polymer together, for example, via the hydroxyl portion of the hydroxyl polymer. Non-limiting examples of suitable crosslinkers include imidazolidinone, polycarboxylic acids, and mixtures thereof. In one example, the cross-linking agent comprises a urea glyoxal adduct cross-linking agent, for example, a dihydroxy imidazolidinone such as dihydroxyethylene urea (“DHEU”). Crosslinking agents may be present in the filament forming composition of the present invention and/or in the filaments to control the solubility and/or dissolution of the filaments in a solvent such as a polar solvent.

As used herein, the additive comprises a rheology modifier such as a shear force modifier and/or an extension modifier. Non-limiting examples of rheology modifiers include, but are not limited to, polyacrylamides, polyurethanes, and polyacrylates that can be used in the filaments of the present invention. Non-limiting examples of rheology modifiers are commercially available from Dow Chemical Company (Midland, MI).

As used herein, the additive may be used when the filament is exposed to the intended application conditions and/or when the active agent is released from the filament and/or when the morphology of the filament changes. To provide a visual signal, it includes one or more colors and/or dyes incorporated into the filaments of the present invention.

As used herein, the additive includes one or more release agents and/or lubricants. Non-limiting examples of suitable release agents and/or lubricants include fatty acids, fatty acid salts, fatty alcohols, aliphatic esters, sulfonated fatty acid esters, aliphatic amine acetates, fatty acid amides, silicones, aminosilicones, fluoropolymers, and mixtures thereof. In one embodiment, the release agent and/or lubricant is applied to the filament, in other words, after the filament is formed. In one example, one or more release agents/lubricants are applied to the filaments prior to collecting the filaments on the collection device to form a nonwoven. In other embodiments, one or more release agents/lubricants are applied to a nonwoven formed from the filaments of the present invention prior to contacting one or more nonwoven webs, such as a stack of nonwoven webs. In yet another embodiment, to facilitate removal of the filaments and/or nonwoven webs of the present invention and/or the layers of the filament/nonwoven webs of the present invention are adhered to each other, and further carelessly adhered. To avoid, the filaments and/or nonwovens comprising the filaments of the present invention may have one or more release agents/before the filaments and/or nonwovens contact the surface (such as the surface of an apparatus used in a processing system). Lubricant is applied. In one example, the release agent/lubricant includes particulates.

As used herein, the additive includes one or more antiblocking agents and/or tack removers. Non-limiting examples of suitable antiblocking and/or detackifying agents include starch, starch derivatives, crosslinked polyvinylpyrrolidone, crosslinked cellulose, microcrystalline cellulose, silica, metal oxides, calcium carbonate, talc, mica, or a combination thereof.

As used herein, “purpose application conditions” refers to the temperature, physical, chemical, and exposure to which the filaments of the invention are exposed when used for one or more of their design purposes. Means mechanical conditions. For example, if the filament and/or the nonwoven web comprising the filament is designed to be used in a washing machine for laundry care purposes, the condition of the intended use is any wash water during the laundry wash operation. Will include these temperatures, chemical, physical, and/or mechanical conditions present in the washing machine. In other examples, if the filament and/or the nonwoven web comprising the filament is designed to be used by humans as a shampoo for hair care purposes, the conditions for the intended use are during human hair shampooing. These temperatures, chemical, physical and/or mechanical conditions that exist will be included. Similarly, if the filament and/or the nonwoven web comprising the filament is designed to be used in a dishwashing operation by hand or by a dishwasher, the intended use condition is that the dishwashing water during the dishwashing operation is and/or these temperatures, chemical, physical, and/or mechanical conditions present in the dishwasher.

As used herein, an “active agent” is used in the environment outside of a filament and/or a nonwoven web comprising the filament of the invention, e.g., the purpose of the filament and/or nonwoven web comprising the filament. By an additive that produces the intended effect when exposed to the conditions of use. In one example, the active agent is a surface, such as a hard surface (i.e., kitchen counter, bathtub, toilet, toilet bowl, sink, floor, wall, tooth, car, window, mirror, dish) and/or a soft surface (i.e., Fabrics, hair, skin, carpets, crops, plants). In other embodiments, the activator is a chemical reaction (i.e., foaming, foaming, coloring, increasing temperature, cooling, foaming, disinfection and/or purification, and/or chlorination, e.g., water purification, and/or water used in the disinfection and/or chlorination of water). In yet another embodiment, the active agent includes an additive that treats the environment (i.e., deodorizes, purifies, or aromas the air). In one example, the active agent is formed in situ, such as during the formation of a filament containing the active agent, e.g., the filament comprises a water soluble polymer (e.g., starch) and a surfactant (e.g., an anionic surfactant). However, they can create polymeric complexes, i.e., coacervates, that function as active agents used to treat the surface of the fabric.

As used herein, “Treat”, with respect to surface treatment means that the active agent provides a benefit to the surface or environment. Treatment includes controlling and/or immediately improving the appearance of the surface or environment, cleanliness, tactile properties, residual treatment, purity, and/or feel. In one example, treatment relating to the treatment of the surface of exterior and/or interior of the car surface wherein the CCS is used to clean, shine, remove oxidation, soften leather or other surfaces in the interior of the vehicle.

“Liquid processing active agent” as used herein means an active agent that provides benefits and/or improvements to a liquid when applied to a liquid such as water and/or alcohol. For example, chlorine and/or car cleaning materials are non-limiting examples of suitable liquid treatment activators. In other examples, clear coat activators, or other types of activator to trigger a benefit of the CCS are suitable for the filaments of the present invention. In addition, oil dispersants and/or oil scavengers are non-limiting examples of other suitable liquid treatment actives.

As used herein, “industrial active agent” means an active agent that provides benefits within the article of manufacture. For example, glues and/or adhesives that provide a bond between two objects, pesticides, food and/or septic articles incorporated in insulators (e.g., housing insulators) Oxygen scavenging active agents incorporated into packages, insect repellents incorporated into articles used by humans to repel insects, and moisture scavengers incorporated into desiccants are present in the filaments of the present invention. Non-limiting examples of industrial activators obtained.

“Weight ratio”, as used herein, refers to the weight of the additive, e.g., the filament-forming material on a dry weight basis in the filament to the active agent (g or %) in the filament on a dry weight basis. It means weight (g or %). The final concentration is expressed as weight percent (wt. %).

As used herein, “hydroxyl polymer” includes any hydroxyl-containing polymer that can be incorporated into the filaments of the present invention, e.g., as a filament-forming material. In one example, the hydroxyl polymer of the present invention comprises greater than 10 wt % and/or greater than 20 wt. % and/or greater than 25 wt. % hydroxyl moieties.

“Biodegradable” as used herein with respect to a material, such as a material, for example as a whole filament and/or as a polymer within a filament (e.g., filament-forming material), for example, at least of the initial filament and/or polymer. 5%, and/or 7%, and/or at least 10% according to OECD (1992) “Guideline for the Testing of Chemicals 301B; Ready Biodegradability-CO₂ Evolution (Modified T) When measured, filaments and/or polymers can be converted to carbon dioxide in public solid waste composting facilities so that they are converted to carbon dioxide after 30 days. They can undergo a beauty/or biodegradable, and/or means that go through it.

“Non-biodegradable” as used herein with reference to materials such as whole filaments and/or polymers within filaments (e.g. filament-forming material) filaments, e.g., at least 5% of the initial filaments and/or polymers. As measured after 30 days as measured according to OECD (1992) “Guideline for the Testing of Chemicals 301B; Ready Biodegradability—CO₂ Evolution (Modified Storm Test) Test” incorporated herein. In particular, it means that the filament and/or polymer cannot undergo physical, chemical, thermal and/or biodegradation.

“Non-thermoplastic” as used herein with respect to materials such as whole filaments and/or polymers within filaments (eg, filament-forming materials), filaments and/or polymers do not exhibit a melting point and/or softening point. This means that when there is no plasticizer such as water, glycerin, sorbitol, urea, it can flow under pressure.

As used herein, “non-thermoplastic biodegradable filament” means a filament that exhibits biodegradable and non-thermoplastic properties as defined above.

As used herein, “non-thermoplastic, non-biodegradable filament” means a filament that exhibits non-biodegradable and non-thermoplastic properties as defined above.

“Thermoplastic” as used herein with respect to materials such as the entire filament and/or polymer within the filament (e.g., filament forming material), the filament and/or polymer has a melting point and/or softening point at a particular temperature. Which allows it to flow under pressure in the absence of a plasticizer.

As used herein, “thermoplastic biodegradable filament” means a filament that exhibits biodegradable and thermoplastic properties as defined above.

As used herein, “thermoplastic, non-biodegradable filament” means a filament that exhibits non-biodegradable and non-thermoplastic properties as defined above.

As used herein, “non-cellulose containing” is less than 5% by weight and/or less than 3% by weight and/or less than 1% by weight and/or less than 0.1% by weight. In addition, it means that weight percent cellulose polymer, cellulose derivative polymer and/or cellulose copolymer is present in the filament. In one example, “non-cellulose-containing” is less than 5% by weight and/or less than 3% by weight and/or less than 1% by weight and/or less than 0.1% by weight and/or 0% by weight.

As used herein, “polar solvent soluble material” means a material that is miscible in a polar solvent. In one example, the polar solvent soluble material is miscible in alcohol and/or water. In other words, the polar solvent soluble material forms a homogeneous solution that is stable at ambient conditions with a polar solvent, such as alcohol and/or water (no phase separation for more than 5 minutes after forming a homogeneous solution).

As used herein, “alcohol soluble material” means a material that is miscible within the alcohol. In other words, it is a material that can form a homogeneous solution that is stable with alcohol at ambient conditions (it does not phase separate for more than 5 minutes after forming a homogeneous solution).

As used herein, “water soluble material” means a material that is miscible in water. In other words, it is a material that can form a homogeneous solution that is stable with water (does not separate for more than 5 minutes after forming a homogeneous solution) at ambient conditions.

As used herein, “nonpolar solvent soluble material” means a material that is miscible in a nonpolar solvent. In other words, a non-polar solvent soluble material is a material that can form a stable solution with a non-polar solvent (which does not phase separate for more than 5 minutes after forming a homogeneous solution).

As used herein, “ambient conditions” means about 23° C.±2.2° C. (about 73° F.±4° F.) and 50%±10% relative humidity.

As used herein, “weight average molecular weight” means gel penetration according to the procedure found in “Colloids and Surfaces A. Physico Chemical & Engineering Aspects” (Vol. 162, 2000, pg. 107-121). It means the weight average molecular weight determined using chromatography.

As used herein with respect to a filament, “length” means the length along the longest axis from one end to the other end. If the filament is kinked, curved, or bent within it, the length is the length along the entire path of the filament.

As used herein with respect to filaments, “diameter” is measured according to the diameter test method described herein. In one embodiment, the filaments of the invention are less than 100 μm and/or less than 75 μm and/or less than 50 μm and/or less than 25 μm and/or less than 20 μm and/or less than 15 μm and/or exhibit a diameter of less than 10 μm and/or less than 6 μm and/or greater than 1 μm and/or greater than 3 μm.

As used herein, in yet another examples, incentive conditions may be present in the environment (e.g., water, etc.) when the filaments and/or nonwoven webs, and/or films of the present invention are added to water. In other words, nothing changes in water except for the fact that the filaments and/or nonwoven webs and/or films of the present invention have been added to water.

As used herein with respect to filament morphological changes, “morphological change” means that the filament experiences a change in its physical structure. Non-limiting examples of morphological changes for the filaments of the present invention include melting, melting, expanding, shrinking, shattering, rupturing, extending, shortening, and combinations thereof. The filaments of the present invention may lose their physical structure completely or substantially when exposed to the intended application conditions, their morphologies may change, or the filaments It can retain or substantially retain the physical structure.

As used herein, “by weight on a dry filament basis” means that the filament is in a room conditioned at a temperature of 23° C.±2.2° C. (approximately 73° F.±4° F.) and a relative humidity of 50%±10% for 2 hours, It means the filament weight measured immediately after being adjusted. In one example, “by weight of dry filament base” refers to the weight of the filament based on the weight of the filament in moisture, eg, free water, as measured, for example, according to the moisture content testing method described herein. Less than 20% and/or less than 15% and/or less than 10% and/or less than 7% and/or less than 5% and/or less than 3% and/or less than 1%.

As used herein with respect to the total concentration of one or more active agents present in the filament, “total concentration” means the total weight or weight percent of all subject material (e.g., active agents). In other words, the filament comprises 50 wt % of perfume or fragrance on a dry filament basis. Optionally an additional 35 wt. % of anionic surfactant on a dry filament basis, 15 wt % nonionic surfactant on a dry filament basis, 10 wt. % chelating agent, and 5 wt. % perfume. So that the total concentration of active perfume or fragrance agent present in the filament is greater than 50% by weight on a dry filament basis.

As used herein, a “web” is a collection of formed fibers and/or filaments (e.g., fibrous structures) and/or fibers and/or filaments of any attribute or origin associated with each other. It means a formed sheet (for example, a continuous filament).

As used herein, the web is a sheet formed by a spinning process rather than a casting gloss.

As used herein, a “nonwoven web” as defined for purposes of the present invention, and generally in the European Disposables and Nonwovens Association (EDANA), is a sheet of fibers and/or filaments (e.g., any means) or the like, continuous filaments of any quality or origin, etc., which can be joined together by any means except weaving or braiding. The felt obtained by wet milling is not a nonwoven web.

As used herein, a nonwoven web according to the present invention refers to regularly arranged filaments within a structure to perform a function.

As used herein, the nonwoven web of the present invention is in an arrangement that includes two or more and/or three or more filaments that are entangled within or otherwise associated with each other to form a nonwoven web. is there.

As used herein the nonwoven web of the present invention may include one or more solid additives, such as particulates and/or fibers, in addition to the filaments of the present invention.

As used herein, “microparticle” means a particulate material and/or powder.

As used herein, the articles “a” and “an” as used herein, such as “an anionic surfactant” or “a fiber” are claimed. Alternatively, it is understood to mean one or more substances described.

As used herein, the percentages and ratios are calculated by weight unless otherwise indicated. All percentages and ratios are calculated based on the total composition unless otherwise indicated.

As used herein, unless otherwise stated, all concentrations of a component or composition relate to the activity level of that component or composition and exclude impurities that may be present in commercial sources, such as residual solvents or by-products. Is done.

As used herein, the filament of the present invention comprises one or more filament forming materials. In addition to the filament forming material, the filament includes one or more active agents that are releasable from the filament, for example when exposed to the conditions of the intended application, and one or more filament forming materials present in the filament. The total concentration is less than 80% by weight on a dry filament basis, and the total concentration of one or more active agents present in the filament is provided above 20% by weight on a dry filament basis.

As used herein, the CCS is produced from one or more filament-forming materials with or without one or more additives (deactivator additives) and then coated with one or more active agents. The filament in contact with is not within the scope of the present invention. However, one or more filament forming materials and filaments formed from one or more active agents, such as one or more filament forming materials with or without one or more inactive agents, and one filament formed from a mixture with the above active materials (i.e., the filament forming composition of the present invention) that are subsequently coated with one or more active agents are within the scope of the present invention.

As used herein the filaments of the present invention include one or more filament forming materials and one or more active agents, wherein the total concentration of filament forming material present in the filaments is about 5 on a dry filament basis. The total concentration of active agent present in the total filament composition is from 50% to less than 50% by weight, or greater than 50% by weight and up to about 95% by weight on a dry filament basis.

As used herein, the filaments of the present invention are about 100% by weight and/or greater than 95%, and/or greater than 90% and/or greater than 85% by weight and/or One or more filament-forming materials comprising more than 75% and/or more than 50% by weight. For example, the filament forming material may comprise polyvinyl alcohol and/or starch or starch derivatives.

As used herein the filaments of the present invention include one or more filament forming materials and one or more active agents, wherein the total concentration of filament forming material present in the filaments is about dry filament basis. The total concentration of active agent present in the filaments, from 5% to less than 80% by weight, is greater than 20% by weight and up to about 95% by weight on a dry filament basis.

As used herein, the filaments of the present invention are at least 10% and/or at least 15% and/or at least 20% and/or less than 80% and/or 75% by weight on a dry filament basis. Less than and/or less than 65% and/or less than 60% and/or less than 55% and/or less than 50% and/or less than 45% and/or less than 40%.

As used herein, the filaments of the present invention are more than 20 wt. % and/or at least 35 wt. %, and/or at least 40 wt. %, and/or at least 50 wt. %, and/or at least 60 wt. %, and/or at least 65 wt. %, and/or less than 95 wt. %.

As used herein, the filaments of the present invention are less than 90 wt %, or less than 85 wt. %, and/or less than 80 wt. %, less than 75 wt. %. The filaments of the present invention comprise greater than 80% by weight active agent on a dry filament basis.

As used herein, the one or more filament forming materials and the active agent have a weight ratio of the total concentration of the filament forming material to the active agent of 4.0 or less, and/or 3.5 or less, and/or 3 0.0 or less and/or 2.5 or less and/or 2.0 or less and/or 1.85 or less and/or less than 1.7 and/or less than 1.6. And/or less than 1.5 and/or less than 1.3 and/or less than 1.2 and/or less than 1 and/or less than 0.7 and/or less than 0.5 And/or less than 0.4 and/or less than 0.3 and/or more than 0.1 and/or more than 0.15 and/or more than 0.2 filaments exists within.

As used herein, the filaments of the present invention comprise from about 10% and/or from about 15% to less than 80% filament-forming material (e.g., polyvinyl alcohol polymer and/or starch polymer) on a dry filament basis. And up to about 90% and/or up to about 85% by weight of additives (e.g., active agents) on a dry filament basis. The filament further comprises a plasticizer, such as glycerin, and/or a pH adjuster, such as citric acid.

As used herein, the filaments of the present invention comprise from about 10% and/or from about 15% to less than 80% filament-forming material (eg, polyvinyl alcohol polymer and/or starch polymer) on a dry filament basis. And, based on dry filaments, greater than 20 wt. %, Up to about 90 wt. % And/or up to about 85 wt. % active agent, wherein the weight ratio of filament forming material to active agent is 40 wt. % or less. The filament further comprises a plasticizer, such as glycerin, and/or a pH adjuster, such as citric acid.

As used herein, the filaments of the present invention comprise about 5% to less than 50% by weight filament forming material (e.g., polyvinyl alcohol polymer and/or starch polymer) on a dry filament basis and 50% on a dry filament basis. And up to about 95% by weight of additives, such as active agents (e.g., perfumes or fragrances or odor removing agents or odor reducing agents or a combination thereof). The filament further comprises a plasticizer, such as glycerin, and/or a pH adjuster, such as citric acid.

As used herein, the filaments of the present invention have 0% to less than 20% and/or 0% to 15%, as measured according to the moisture content test method described herein. Less than 15% and/or more than 0% and less than 15% and/or more than 0% and less than 12% and/or more than 2% and less than 10 wt. %.

As used herein, the filaments of the present invention have from about 5 wt % to about 10 wt %, and/or from about 7 wt % to about 10 wt %, as measured according to the moisture content test method described herein.

As used herein, the filament comprises one or more filament forming materials and enzymes, bleaches, builders, chelates that are releasable and/or released when the filament is exposed to the intended application conditions. And one or more active agents selected from the group consisting of these agents, and mixtures thereof.

As used herein, the filaments are less than 95% and/or less than 90%, and/or less than 80%, and/or less than 50%, and/or less than 35%, and/or less, on a dry filament basis, and/or up to about 5% by weight and/or up to about 10% by weight and/or up to about 20% by weight of the total concentration of filament-forming material and more than 5% and/or 10% by weight on a dry filament basis.

As used herein, the filaments are more than 20% and/or more than 35% and/or more than 50% and/or more than 65% and/or up to about 95% by weight of a total concentration of active agents selected from the group consisting of enzymes, bleaches, builders, chelating agents, and mixtures thereof.

As used herein, the filaments of the present invention may contain active agents that may raise health and/or safety concerns when they are airborne. For example, the filament may be used to prevent enzymes in the filament from floating in the air.

As used herein, the filaments of the present invention may be meltblown filaments.

As used herein, the filaments of the present invention may be spunbond filaments.

As used herein the filament may be a hollow filament before and/or after release of one or more of its active agents.

As used herein, the filaments of the present invention may be hydrophilic or hydrophobic. The filaments may be surface treated and/or treated internally to alter the filament's inherent hydrophilic or hydrophobic properties.

As used herein, the filament is less than 100 μm, and/or less than 75 μm, and/or less than 50 μm, and/or less than 25 μm, and/or less than 10 μm, as measured according to the diameter test method described herein.

As used herein, the diameter of the filament may be less than 5 μm and/or less than 1 μm in diameter.

As used herein, the filaments of the present invention exhibit a diameter of greater than 1 μm as measured according to the diameter test method described herein. The diameter of the filaments of the present invention may be used to control the release rate of one or more active agents present in the filament and/or the loss of and/or changing the physical structure of the filament.

As used herein, the filament may contain two or more different active agents.

As used herein, the filament includes two or more different active agents, the two or more different active agents being compatible with each other.

As used herein the filament includes two or more different active agents, and the two or more different active agents are incompatible with each other.

As used herein, the filament may include an active agent within the filament and an active agent on the outer surface of the filament, such as a coating on the filament. The active agent on the outer surface of the filament may be the same as or different from the active agent present in the filament. If different, the active agents may be compatible with each other or incompatible.

As used herein, the filaments of the present invention do not contain preservatives, which for the purposes of the present invention are based on dry filaments, less than 2%, and/or less than 1%, and/or 0. Means less than 5% and/or less than 0.25% and/or 0% preservative.

As used herein, the one or more active agents may be uniformly dispersed throughout the filament or may be substantially uniformly dispersed.

As used herein, one or more active agents may be dispersed as separate regions within the filament.

As used herein, the at least one active agent is uniformly or substantially uniformly dispersed throughout the filament, and at least the other active agent is dispersed as one or more separate regions within the filament.

As used herein, at least one active agent is dispersed as one or more discrete regions within the filament, and the at least one other active agent is one or more from the first separate region within the filament. The filament may be used as a separate article.

As used herein, the filament is a carrier substrate (eg, wipe, wash cloth, dryer sheet, fabric, garment, underwear, shine, protection from sun, moisture, dirt, etc.) and/or deposited thereon.

As used herein, the plurality of filaments of the present invention are collected into and compressed into a film and thus released from the film when one or more filament forming materials and, for example, the film is exposed to the intended application conditions. It can be a film comprising one or more active agents that are possible.

As used herein, the films of the present invention have a per sample less than than 100 seconds, and/or less than 80 seconds, and/or as measured according to the dissolution test methods described herein. It exhibits an average degradation time of less than 55 seconds and/or less than 50 seconds and/or less than 40 seconds and/or less than 30 seconds and/or 20 seconds/g (s/g).

As used herein, the films of the present invention have a per sample less than 1000 seconds, and/or less than 900 seconds, and/or less than 800 seconds, and/or as measured according to the dissolution test methods described herein. Alternatively, it exhibits an average degradation time of less than 700 seconds and/or less than 600 seconds and/or less than 500 seconds/g (s/g).

As used herein, the film of the present invention has a thickness greater than 0.01 mm and/or greater than 0.05 mm and/or 0.1 mm as measured by the thickness test method described herein.

As used herein, the film of the present invention may be greater than and/or up to about 20 mm and/or up to about 10 mm and/or up to about 5 mm and/or up to about 2 mm and/or up to 0.5 mm and/or about 0. The film thickness may be up to 3 mm.

As used herein, the filament-forming material is any suitable material, such as a polymer or monomer that can produce a polymer that exhibits properties suitable for making filaments, such as by a spinning process.

As used herein, the filament forming material may comprise a polar solvent soluble material, such as an alcohol soluble material and/or a water soluble material.

As used herein, the filament forming material may include a non-polar solvent soluble material.

As used herein, the filament forming material may include a polar solvent soluble material and may not include a non-polar solvent soluble material (less than 5% by weight and/or 3% by weight on a dry filament basis). Less than and/or less than 1% by weight and/or 0% by weight).

As used herein, the filament forming material may be a film forming material. In yet other embodiments, the filament-forming material may be synthetic or naturally derived, which may be chemically, enzymatically and/or physically modified.

As used herein, the filament forming material is a polymer derived from acrylic monomers such as ethylenically unsaturated carboxylic acid monomers and ethylenically unsaturated monomers, polyvinyl alcohol, polyacrylates, polymethacrylates, Copolymers of acrylic acid and methyl acrylate, polyvinyl pyrrolidone, polyalkylene oxide, starch and starch derivatives, pullulan, gelatin, hydroxylpropyl methylcellulose, methylcellulose, and polymers selected from the group consisting of carboxymethylcellulose may be included.

As used herein, the filament forming material is polyvinyl alcohol, polyvinyl alcohol derivative, starch, starch derivative, cellulose derivative, hemicellulose, hemicellulose derivative, protein, sodium alginate, hydroxypropylmethylcellulose, chitosan, chitosan derivative, polyethylene glycol, tetra It may include a polymer selected from the group consisting of methylene ether glycol, polyvinyl pyrrolidone, hydroxymethyl cellulose, hydroxyethyl cellulose, and mixtures thereof.

As used herein, the filament-forming material comprises pullulan, hydroxypropylmethylcellulose, hydroxyethylcellulose, hydroxypropylcellulose, polyvinylpyrrolidone, carboxymethylcellulose, sodium alginate, xanthan gum, tragacanth gum, guar gum, acacia gum, gum arabic, polyacrylic acid, methyl Methacrylate copolymer, carboxyvinyl polymer, dextrin, pectin, chitin, levan, erucinane, collagen, gelatin, zein, gluten, soy protein, casein, polyvinyl alcohol, starch, starch derivative, hemicellulose, hemicellulose derivative, protein, chitosan, chitosan derivative, Polyethylene glycol, tetramethylene ether glycol, Mud carboxymethylcellulose, and comprises a polymer selected from the group consisting of mixtures.

As used herein, the polar solvent-soluble materials include polar solvent-soluble polymers. The polar solvent soluble polymer may be synthetic or naturally derived and may be chemically and/or physically modified.

As used herein, the polar solvent soluble polymer is at least about 10,000 g/mol, and/or at least about 20,000 g/mol, and/or at least 40,000 g/mol, and/or at least 80,000 g/mol, And/or at least about 100,000 g/mol, and/or at least 1,000,000 g/mol, and/or at least 3,000,000 g/mol, and/or at least 10,000,000 g/mol, and/or It exhibits a weight average molecular weight of at least 20,000,000 g/mol and/or up to about 40,000,000 g/mol and/or up to about 30,000,000 g/mol.

As used herein, the polar solvent soluble polymer is selected from the group consisting of alcohol soluble polymers, water soluble polymers, and mixtures thereof. Non-limiting examples of water soluble polymers include water soluble hydroxyl polymers, water soluble thermoplastic polymers, water soluble degradable polymers, water soluble non biodegradable polymers, and mixtures thereof.

As used herein, the water soluble polymer comprises polyvinyl alcohol. In other examples, the water soluble polymer comprises starch. In yet another embodiment, the water soluble polymer comprises polyvinyl alcohol and starch.

As used herein, the solvent consists of a water-soluble hydroxyl polymers according to the present invention include polyols such as polyvinyl alcohol, polyvinyl alcohol derivatives, polyvinyl alcohol copolymers, starch, starch derivatives, starch copolymers, chitosan, chitosan derivatives, Chitosan copolymers, cellulose, cellulose derivatives, such as cellulose ether and ester derivatives, cellulose copolymers, hemicellulose, hemicellulose derivatives, hemicellulose copolymers, gums, arabinans, galactants, proteins and various other polysaccharides, and mixtures thereof.

As used herein, the water soluble hydroxyl polymer of the present invention comprises a polysaccharide. As used herein, “polysaccharide” means natural polysaccharides and polysaccharide derivatives or modified polysaccharides. Suitable water soluble polysaccharides include, but are not limited to starch, starch derivatives, chitosan, chitosan derivatives, cellulose derivatives, hemicellulose, hemicellulose derivatives, gums, arabinans, galactans, and mixtures thereof. The water-soluble polysaccharide is from about 10,000 g/mole to about 40,000,000 g/mole and/or more than 100,000 g/mole and/or more than 1,000,000 g/mole. Alternatively, it may exhibit a weight average molecular weight of greater than 3,000,000 g/mol and/or greater than about 3,000,000 g/mol and up to about 40,000,000 g/mol.

As used herein, the water-soluble polysaccharide may comprise non-cellulose and/or non-cellulose derivatives and/or non-cellulose copolymer water-soluble polysaccharides. Such non-cellulose soluble polysaccharides may be selected from the group consisting of starch, starch derivatives, chitosan, chitosan derivatives, hemicellulose derivatives, hemicellulose derivatives, gums, arabinans, galactans, and mixtures thereof.

As used herein, the water soluble hydroxyl polymer of the present invention comprises a non-thermoplastic polymer. As used herein, the water-soluble hydroxyl polymer can be from about 10,000 g/mol to about 40,000,000 g/mol, and/or more than 100,000 g/mol, and/or more than 1,000,000 g/mol, and/or more than 3,000,000 g/mol and up to about 40,000,000 g/mol. Higher and lower molecular weight water-soluble hydroxyl polymers may be used in conjunction with hydroxyl polymers having a weight average molecular weight within a particular desired range.

As used herein, the water soluble hydroxyl polymers may be selected from natural starch and include chemical and/or enzymatic modifications. As used herein, the water soluble hydroxyl polymer may be combined with native starch which can further be acid-thinned, hydroxyethylated, hydroxypropylated, and/or oxidized. As used herein, the water soluble hydroxyl polymer may comprise dent corn starch.

As used herein, the naturally occurring starch is generally consisting of a mixture of linear amylose and branched amylopectin polymers of D glucose units. Amylose is essentially a linear polymer of D-glucose linked by (1,4)-α-D bonds. Aminopectin is a highly branched polymer of (1,4)-α-D bonds and (1,6)-α-D-glucose units at branch points. Naturally occurring starch is typically a relatively high concentration of amylopectin, such as corn starch (64-80% amylopectin), waxy maize (93-100% amylopectin), rice (83-84% amylopectin), potato (About 78% amylopectin) and wheat (73-83% amylopectin). Although all starches are potentially useful herein, the present invention is most commonly practiced with high amylopectin natural starch derived from agricultural sources, which is an abundant source and can be easily supplemented and offers the advantage of being inexpensive.

As used herein, the “starch” includes any naturally occurring unmodified starch, modified starch, synthetic starch, and mixtures thereof, and mixtures of amylose or amylopectin fractions, It may be modified by chemical, chemical, or biological processes, or combinations thereof.

As used herein, the unmodified or modified starch may depend on the desired end product.

As used herein, the starch or starch mixture useful in the present invention is from about 20% to about 100%, more typically from about 40% to about 90%, even more typically. Having an amylopectin content from about 60 wt % to about 85 wt % starch or mixtures thereof.

As used herein, suitable starches of natural origin include: corn starch, potato starch, sweet potato starch, wheat starch, sago palm starch, tapioca starch, rice starch, soybean starch, arrow root starch, amino starch, bracken starch, lotus starch, Non-limiting examples include waxy corn starch and high amylose corn starch. Naturally occurring starches, particularly corn starch and wheat starch, are preferred starch polymers due to their economics and availability.

As used herein, the polyvinyl alcohol herein can be grafted with other monomers to improve its properties. A wide range of monomers have been successfully grafted to polyvinyl alcohol. Non-limiting examples of such monomers include vinyl acetate, styrene, acrylamide, acrylic acid, 2-hydroxyethyl methacrylate, acrylonitrile, 1,3-butadiene, methyl methacrylate, methacrylic acid, maleic acid, itaconic acid, vinyl sulfonic acid. Sodium, sodium allyl sulfonate, sodium methyl allyl sulfonate, sodium phenyl allyl ether sulfonate, sodium phenyl methallyl ether sulfonate, 2-acrylamido-methyl propane sulfonic acid (AMPs), vinylidene chloride, vinyl chloride, vinyl amine, and acrylate esters.

As used herein, the water soluble hydroxyl polymer is selected from the group consisting of polyvinyl alcohol, hydroxymethylcellulose, hydroxyethylcellulose, hydroxypropylmethylcellulose, and mixtures thereof. Non-limiting examples of suitable polyvinyl alcohols include those commercially available from Sekisui Specialty Chemicals America, LLC (Dallas, TX) under the trade name CELVOL®. Non-limiting examples of suitable hydroxypropyl methylcellulose include those commercially available from Dow Chemical Company (Midland, MI) under the trademark METHOCEL®, including combinations with the hydroxypropyl methylcellulose described above.

As used herein, the water-soluble thermoplastic polymers consists of examples of suitable water-soluble thermoplastic polymers include thermoplastic starch and/or starch derivatives, polylactic acid, polyhydroxyalkanoates, polycaprolactones, polyester amides, and certain polyesters or a combination thereof.

As used herein, the water-soluble thermoplastic polymer of the present invention may be hydrophilic or hydrophobic.

As used herein, the water soluble thermoplastic polymer may be surface treated and/or internally treated to alter the hydrophilic or hydrophobic properties inherent in the thermoplastic polymer.

As used herein, the water soluble thermoplastic polymer may comprise a biodegradable polymer. Any suitable weight average molecular weight may be used for the thermoplastic polymer. For example, the weight average molecular weight of the thermoplastic polymer according to the present invention is greater than about 10,000 g/mole and/or greater than about 40,000 g/mole and/or greater than about 50,000 g/mole. And/or less than about 500,000 g/mole and/or less than about 400,000 g/mole and/or less than about 200,000 g/mole.

As used herein, the non-polar solvent soluble materials include non-polar solvent soluble polymers. Non-limiting examples of suitable non-polar solvent soluble materials include cellulose, chitin, chitin derivatives, polyolefins, polyesters, copolymers thereof, and mixtures thereof. Non-limiting examples of polyolefins include polypropylene, polyethylene, and mixtures thereof. Non-limiting examples of polyesters include polyethylene terephthalate.

As used herein, nonpolar solvent soluble materials may include non-biodegradable polymers such as polypropylene, polyethylene, and certain polyesters. Any suitable weight average molecular weight may be used for the thermoplastic polymer. For example, the weight average molecular weight of the thermoplastic polymer according to the present invention is greater than about 10,000 g/mole and/or greater than about 40,000 g/mole and/or greater than about 50,000 g/mole. And/or less than about 500,000 g/mole and/or less than about 400,000 g/mole and/or less than about 200,000 g/mole.

As used herein, activators are a class of additives designed and intended to benefit something other than the filament itself, for example, benefiting the environment outside the filament. The active agent may be any suitable additive that produces the intended effect under the intended use of the filament. For example, the active agent may be a CCS that is designed to be added to water or other solvents to wash the vehicle. The active agent in the CCS may be used directly onto the car interior and/or exterior surface to deliver benefits that are typically achieved during the car cleaning process.

As used herein, a CCS containing a conditioning agent, such as fabric care agents, fabric conditioning agents, fabric softeners, fabric anti-wrinkle agents, fabric care antistatic agents, fabric care stain removers, soil release agents, dispersants, foam inhibitors, foaming agents, antifoaming agents, fabric refreshing agents; hard surface care and/or conditioning agents, and abrasives; other cleaning and conditioning agents such as antibacterial agents, perfumes, bleaches (e.g. oxygen bleaching), hydrogen peroxide, percarbonate bleach, perborate bleach, chlorine bleach), bleach activator, chelating agent, builder, lotion, whitening agent, air care agent, carpet care agent, dye transfer inhibitor, water softener, pH adjuster, enzyme, flocculant, foaming agent, preservative, cosmetic agent, makeup remover, foaming agent, adhesion aid, coacervate forming material, clay, thickener, latex, silica, desiccant or a combination thereof.

As used herein, the composition may contain one or more classes of chemicals that may be useful for one or more of the active agents listed above. For example, a surfactant active may be useful for any number of the active agents described above. Similarly, bleach can be used in fabric care, hard surface cleaning, dishwashing, and even tooth whitening. Thus, those skilled in the art will appreciate that the active agent is selected based on the desired intended use of the filament and/or the nonwoven fabric made therefrom.

As used herein, the filaments of the present invention and/or nonwovens made therefrom should be used for hair care and/or conditioning thereof, whereby one or more surfactants, such as foamable surfactants, Filaments and/or non-woven fabrics incorporating filaments can be selected to provide the desired benefits to the consumer when exposed to the intended application conditions.

As used herein, the filaments of the invention and/or nonwovens made therefrom are designed or intended for use in the cleaning of the interior surface of the car such as the seats and any other porous surfaces inside the vehicle. The CCS may be used alone or in combination with water or other solvents. In order to achieve said car interior benefit, one or more suitable surfactants, or enzymes, or builders, or fragrances, or foam suppressors, or bleaching agents are desired when exposed to the intended use conditions of the filaments and/or nonwovens incorporating the filaments, an be chosen to provide consumers with the benefits.

As used herein, the active agent comprises a non-surfactant. As used herein, the active agent comprises an inactive active agent, i.e., an active agent other than an ingestible active agent.

As used herein, non-limiting examples of suitable surfactants include anionic surfactants, or cationic surfactants, or nonionic surfactants, or zwitterionic surfactants, or amphoteric surfactants, or a combination thereof. A co-surfactant may also be included in the filament. For example, for filaments designed for delivering cleaning benefits, the total surfactant concentration should be sufficient to provide cleaning including stain and/or odor removal, generally, in the range of about 0.5% to about 95%. In addition, surfactant systems comprising two or more surfactants designed for use in the car cleaning filaments are fully anionic surfactant systems, or a combination of two or more different anionic surfactants, or a mixture of different types of surfactant system, or a combination thereof.

As used herein, a surfactant or a combination of surfactants may be linear or branched surfactants. As used herein suitable linear surfactants include those derived from agricultural chemical oils, such as coconut oil, palm kernel oil, soybean oil, or other vegetable oils.

As used herein, the suitable anionic surfactants may include alkyl sulfates, alkyl ether sulfates, branched alkyl sulfates, branched alkyl alkoxylates, branched alkoxylate sulfates, medium chain branched alkyl allyl sulfonate, sulfated monoglyceride, sulfonated olefin, alkyl allyl sulfonate, primary or secondary alkane sulfonate, alkyl sulfosuccinate, acyl taurate, acyl isethionate, alkyl glyceryl ether sulfonate, sulfonated methyl ester, sulfonated fatty acid, alkyl phosphate, acyl glutamate, acrylic sarcosinate, alkyl sulfoacetate, acylated peptide, alkyl ether carboxylate, anionic fluorosurfactants, sodium lauroyl glutamate, or a combinations thereof.

As used herein, the suitable alkyl sulfates and alkyl ether sulfates for use herein include materials having the corresponding formulas ROSO₃M and RO(C₂H₄O)ₓSO₃M, wherein R Is an alkyl or alkenyl from about 8 to about 24 carbon atoms, x is 1-10, and M is a water-soluble cation such as ammonium, sodium, potassium, and triethanolamine. Other suitable anionic surfactants are MacCutcheon's “Detergents and Emulsifiers” (North American Edition (1986), Allred Publishing Corp.) and McCutcheon's “Functional Materials 92” (Natural Publishing Corp.).

As used herein, anionic surfactants useful in the filaments of the present invention, C₉-C₁₅ alkyl benzene sulfonates (LAS), C₈-C₂₀ alkyl ether sulfates, such as alkyl poly (ethoxy) sulfates, C₈˜C₂₀ alkyl sulfates, and mixtures thereof. Other anionic surfactants may include methyl ester sulfonate (MES), methyl ester etchelate (MEE), sulfonated estolides, and mixtures thereof.

As used herein, the anionic surfactant is a C₁₁-C₁₈ alkyl benzene sulfonate (“LAS”) and primary branched chain, and a random C₁₀-C₂₀ alkyl sulfate (“AS”), formula CH₃(CH₂)x CHOSO₃-M+)CH₃ and CH₃(CH₂)_{y}(CHOSO₃-M+) C₁₀˜C₁₈ secondary of CH₂CH₃ (2,3) alkyl sulfates (formula In which x and (y+1) are integers of at least about 7, preferably about 9, and M is a water-solubilizing cation, in particular sodium, an unsaturated sulfate such as oleyl sulfate), C₁₀-C₁₈ α-sulfonated fatty acid esters, C₁₀-C₁₈ sulfated alkyl polyglycosides, C₁₀-C₁₈ alkyl alkoxy sulfates (“AEₓS”) (the formula x is 1 to 30), and C₁₀-C₁₈ alkyl alkoxy Ruboxylates (eg containing 1-5 ethoxy units), medium chain branched alkyl sulfates as described in U.S. Pat. Nos. 6,020,303 and 6,060,443; US Pat. No. 6,008, medium chain branched alkyl alkoxy sulfates (MLAS) as described in 181 and 6,020,303; as described in WO 99/05243, WO 99/05242, and WO 99/05244 Modified alkylbenzene sulfonate (MILAS); methyl ester sulfonate (MES); and alpha-olefin sulfonate (AOS).

As used herein, other suitable anionic surfactants that can be used are alkyl ester sulfonate surfactants, including sulfonated linear esters of C₈ to C₂₀ carboxylic acids (ie fatty acids). The Other suitable anionic surfactants that can be used salts of soap, C₈-C₂₂ primary or secondary alkane sulfonates (primary of secondary alkanesulfonates), C8˜C24 olefin sulfonates, sulfonated polycarboxylic acids, C₈-C₂₄ alkyl polyglycol ether sulfates (alkylpolyglycolethersulfates) (contain ethylene oxide up to 10 moles); alkyl glycerol sulfonates, fatty acyl glycerol sulfonates, fatty oleoyl glycerol sulfates, alkyl phenol ethylene oxide ether sulfates, paraffin sulfonates, alkyl phosphates, isethionates, eg acyl isethionates, N-acyl taurates, alkyl succinates and sulfosuccinates, monoesters of sulfosuccinates (e.g. saturated and unsaturated C₁₂-C₁₈ monoesters) monoester, diester sulfosuccinates (e.g., saturated and unsaturated C₆-C₁₂ diesters), and alkyl polysaccharide sulfates, such as alkyl polysaccharides sulfates, and alkyl polyethoxy carboxylates such as those of the formula RO(CH₂CH₂O)k-CH₂COO-M+ (wherein R is a C₈-C₂₂ alkyl, k is an integer of 0, M is a soluble salt-forming cation).

As used herein, other suitable anionic surfactants are alkyl benzene sulphonic acid of C₁₀-C₁₆, preferably an alkali metal salt of alkylbenzene sulfonic acid C₁₁-C₁₄.

As used herein, the suitable anionic surfactants are linear alkyl group is linear such as alkyl benzene sulfonates are known as “LAS”. Such surfactants and their preparation are described, for example, in U.S. Pat. Nos. 2,220,099 and 2,477,383. In other examples, linear alkyl sulfonate or linear alkylbenzene sulfonate or liner alkyl benzene sulfonate.

As used herein, the respect to filaments, “diameter” is measured according to the diameter test method described herein. In one embodiment, the filaments of the invention are less than 100 μm and/or less than 75 μm and/or less than 50 μm and/or less than 25 μm and/or less than 20 μm and/or less than 15 μm And/or exhibit a diameter of less than 10 μm and/or less than 6 μm and/or greater than 1 μm and/or greater than 3 μm.

As used herein, an “incentive condition”, in one example, functions as a stimulus in the filament and changes (eg, loss or change in the physical structure of the filament, and/or additives such as activators) Means any activity or phenomenon that initiates or promotes the release of In other examples, incentive conditions may be present in the environment (eg, water, etc.) when the filaments and/or nonwoven webs, and/or films of the present invention are added to water. In other words, nothing changes in water except for the fact that the filaments and/or nonwoven webs and/or films of the present invention have been added to water.

As used herein with respect to filament morphological changes, “morphological change” means that the filament experiences a change in its physical structure. Non-limiting examples of morphological changes for the filaments of the present invention include melting, melting, expanding, shrinking, shattering, rupturing, extending, shortening, and combinations thereof. The filaments of the present invention may lose their physical structure completely or substantially when exposed to the intended application conditions, their morphologies may change, or the filaments It can retain or substantially retain the physical structure.

“By weight on a dry filament basis” means that the filament is in a room conditioned at a temperature of 23° C.±2.2° C. (approximately 73° F.±4° F.) and a relative humidity of 50%±10% for 2 hours, It means the filament weight measured immediately after being adjusted. In one example, “by weight of dry filament base” refers to the weight of the filament based on the weight of the filament in moisture, eg, free water, as measured, for example, according to the moisture content testing method described herein. Less than 20% and/or less than 15% and/or less than 10% and/or less than 7% and/or less than 5% and/or less than 3% and/or up to 0% and/or 0 It means that it contains more than %.

As used herein with respect to the total concentration of one or more active agents present in the filament, “total concentration” means the total weight or weight percent of all subject material (eg, active agents). In other words, the filament comprises 20 wt % of an anioinic surfactant on a dry filament basis, 15 wt % nonionic surfactant on a dry filament basis, 10 wt % chelating agent, and 2 wt % perfume.

As used herein, a “web” is a collection of formed fibers and/or filaments (eg, fibrous structures) and/or fibers and/or filaments of any attribute or origin associated with each other. It means a formed sheet (for example, a continuous filament). In one embodiment, the web is a sheet formed by a spinning process rather than a castin gloss.

As used herein, a “nonwoven web” as defined for purposes of the present invention, and generally in the European Disposables and Nonwovens Association (EDANA), is a sheet of fibers and/or filaments (eg, any means) Or the like, continuous filaments of any quality or origin, etc., which can be joined together by any means except weaving or braiding. The felt obtained by wet milling is not a nonwoven web. In one embodiment, a nonwoven web according to the present invention refers to regularly arranged filaments within a structure to perform a function. In one embodiment, the nonwoven web of the present invention is in an arrangement that includes two or more and/or three or more filaments that are entangled within or otherwise associated with each other to form a nonwoven web. is there. In one example, the nonwoven web of the present invention may include one or more solid additives, such as particulates and/or fibers, in addition to the filaments of the present invention.

As used herein, “microparticle” means a particulate material and/or powder.

As used herein, the articles “a” and “an” as used herein, such as “an anionic surfactant” or “a fiber” are claimed. Alternatively, it is understood to mean one or more substances described.

All percentages and ratios are calculated by weight unless otherwise indicated. All percentages and ratios are calculated based on the total composition unless otherwise indicated.

Unless otherwise stated, all concentrations of a component or composition relate to the activity level of that component or composition and exclude impurities that may be present in commercial sources, such as residual solvents or by-products. Is done.

Filament The filament of the present invention comprises one or more filament forming materials. In addition to the filament forming material, the filament includes one or more active agents that are releasable from the filament, for example when exposed to the conditions of the intended application, and one or more filament forming materials present in the filament. The total concentration is less than 80% by weight on a dry filament basis, and the total concentration of one or more active agents present in the filament is provided above 20% by weight on a dry filament basis.

Formed from one or more filament-forming materials with or without one or more additives (deactivator additives) and then coated with one or more active agents The filament in contact with is not within the scope of the present invention. However, one or more filament forming materials and filaments formed from one or more active agents, such as one or more filament forming materials with or without one or more inactive agents, and one Filaments formed from a mixture with the above active materials (ie, the filament forming composition of the present invention) that are subsequently coated with one or more active agents are within the scope of the present invention.

In one embodiment, the filaments of the present invention include one or more filament forming materials and one or more active agents, wherein the total concentration of filament forming material present in the filaments is about 5 on a dry filament basis. The total concentration of active agent present in the filaments, from 50% to less than 50% by weight, is greater than 50% by weight and up to about 95% by weight on a dry filament basis.

In one embodiment, the filaments of the present invention are about 100% by weight and/or greater than 95%, and/or greater than 90% and/or greater than 85% by weight and/or One or more filament-forming materials comprising more than 75% and/or more than 50% by weight. For example, the filament forming material may comprise polyvinyl alcohol and/or starch or starch derivatives.

In other embodiments, the filaments of the present invention include one or more filament forming materials and one or more active agents, wherein the total concentration of filament forming material present in the filaments is about dry filament basis. The total concentration of active agent present in the filaments, from 5% to less than 80% by weight, is greater than 20% by weight and up to about 95% by weight on a dry filament basis.

In one embodiment, the filaments of the present invention are at least 10% and/or at least 15% and/or at least 20% and/or less than 80% and/or 75% by weight on a dry filament basis. Less than and/or less than 65% and/or less than 60% and/or less than 55% and/or less than 50% and/or less than 45% and/or less than 40% More than 20% and/or at least 35%, and/or at least 40%, and/or at least 45%, and/or at least 50%, and/or at least 60 wt %, and/or at least 65 wt %, and/or less than 95 wt %, and/or less than 90 wt %, Beauty/or less than 85 wt %, and/or less than 80 wt %, including and/or an activator of less than 75 wt %, a. The filaments of the present invention comprise greater than 80% by weight active agent on a dry filament basis.

In other embodiments, the one or more filament forming materials and the active agent have a weight ratio of the total concentration of the filament forming material to the active agent of 4.0 or less, and/or 3.5 or less, and/or 3 0.0 or less and/or 2.5 or less and/or 2.0 or less and/or 1.85 or less and/or less than 1.7 and/or less than 1.6. And/or less than 1.5 and/or less than 1.3 and/or less than 1.2 and/or less than 1 and/or less than 0.7 and/or less than 0.5 And/or less than 0.4 and/or less than 0.3 and/or more than 0.1 and/or more than 0.15 and/or more than 0.2 filaments exists within.

In yet another embodiment, the filaments of the present invention comprise from about 10% and/or from about 15% to less than 80% filament-forming material (eg, polyvinyl alcohol polymer and/or starch polymer) on a dry filament basis. And up to about 90% and/or up to about 85% by weight of additives (eg active agents) on a dry filament basis. The filament further comprises a plasticizer, such as glycerin, and/or a pH adjuster, such as citric acid.

In yet another embodiment, the filaments of the present invention comprise from about 10% and/or from about 15% to less than 80% filament-forming material (eg, polyvinyl alcohol polymer and/or starch polymer) on a dry filament basis). And, based on dry filaments, greater than 20 wt. %, Up to about 90 wt. % And/or up to about 85 wt. % active agent, wherein the weight ratio of filament forming material to active agent is 4.0 or less. The filament further comprises a plasticizer, such as glycerin, and/or a pH adjuster, such as citric acid.

In yet another embodiment, the filaments of the present invention comprise about 5% to less than 50% by weight filament forming material (eg, polyvinyl alcohol polymer and/or starch polymer) on a dry filament basis and 50% on a dry filament basis. And up to about 95% by weight of additives, such as active agents (eg, perfumes and/or fragrances). The filament further comprises a plasticizer, such as glycerin, and/or a pH adjuster, such as citric acid.

In yet another embodiment of the present invention, the filaments of the present invention have 0% to less than 20% and/or 0% to 15%, as measured according to the moisture content test method described herein. Less than 15% and/or more than 0% and less than 15% and/or more than 0% and less than 12% and/or more than 2% and less than 10% and/or 4% Contains more than 8% by weight of water. In one example, the filaments of the present invention have from about 5 wt % to about 10 wt %, and/or from about 7 wt % to about 10 wt %, as measured according to the moisture content test method described herein.

In yet another embodiment of the present invention, the filament comprises one or more filament forming materials and enzymes, bleaches, builders, chelates that are releasable and/or released when the filament is exposed to the intended application conditions. And one or more active agents selected from the group consisting of these agents, and mixtures thereof. In one example, the filaments are less than 95% and/or less than 90%, and/or less than 80%, and/or less than 50%, and/or less than 35%, and/or less, on a dry filament basis, and/or up to about 5% by weight and/or up to about 10% by weight and/or up to about 20% by weight of the total concentration of filament-forming material and more than 5% and/or 10% by weight on a dry filament basis. And/or more than 20% and/or more than 35% and/or more than 50% and/or more than 65% and/or up to about 95% and/or Up to about 90% by weight and/or up to about 80% by weight of a total concentration of active agents selected from the group consisting of builders, chelating agents, and mixtures thereof.

In yet another embodiment of the present invention, the filaments of the present invention may contain active agents that may raise health and/or safety concerns when they are airborne. For example, the filament may be used to prevent enzymes in the filament from floating in the air.

In one embodiment, the filaments of the present invention may be meltblown filaments. In other embodiments, the filaments of the present invention may be spunbond filaments. In other examples, the filament may be a hollow filament before and/or after release of one or more of its active agents.

The filaments of the present invention may be hydrophilic or hydrophobic. The filaments may be surface treated and/or treated internally to alter the filament's inherent hydrophilic or hydrophobic properties.

In one example, the filament is less than 100 μm, and/or less than 75 μm, and/or less than 50 μm, and/or less than 25 μm, and/or less than 10 μm, as measured according to the diameter test method described herein. And/or exhibit a diameter of less than 5 μm and/or less than 1 μm. In other examples, the filaments of the present invention exhibit a diameter of greater than 1 μm as measured according to the diameter test method described herein. The diameter of the filaments of the present invention may be used to control the release rate of one or more active agents present in the filament and/or the loss of and/or changing the physical structure of the filament.

The filament may contain two or more different active agents. In one embodiment, the filament includes two or more different active agents, the two or more different active agents being compatible with each other. In other embodiments, the filament includes two or more different active agents, and the two or more different active agents are incompatible with each other.

In one example, the filament may include an active agent within the filament and an active agent on the outer surface of the filament, such as a coating on the filament. The active agent on the outer surface of the filament may be the same as or different from the active agent present in the filament. If different, the active agents may be compatible with each other or incompatible.

In one embodiment, the filaments of the present invention do not contain preservatives, which for the purposes of the present invention are based on dry filaments, less than 2%, and/or less than 1%, and/or 0. Means less than 5% and/or less than 0.25% and/or 0% preservative.

In one example, the one or more active agents may be uniformly dispersed throughout the filament or may be substantially uniformly dispersed. In other examples, one or more active agents may be dispersed as separate regions within the filament. In yet other embodiments, the at least one active agent is uniformly or substantially uniformly dispersed throughout the filament, and at least the other active agent is dispersed as one or more separate regions within the filament. In yet other embodiments, the at least one active agent is dispersed as one or more discrete regions within the filament, and the at least one other active agent is one or more from the first separate region within the filament.

The filament may be used as a separate article. In one embodiment, the filament is a carrier substrate (eg, wipe, paper towel, toilet paper, decorative paper, sanitary napkin, tampon, diaper, adult incontinence article, wash cloth, dryer sheet, laundry sheet, laundry Bar, dry cleaning sheet, mesh product, filter paper, fabric, garment, underwear, etc.) and/or deposited thereon.

In addition, the plurality of filaments of the present invention are collected into and compressed into a film and thus released from the film when one or more filament forming materials and, for example, the film is exposed to the intended application conditions. It can be a film comprising one or more active agents that are possible.

In one example, the films of the present invention have a per sample less than than 100 seconds, and/or less than 80 seconds, and/or as measured according to the dissolution test methods described herein. It exhibits an average degradation time of less than 55 seconds and/or less than 50 seconds and/or less than 40 seconds and/or less than 30 seconds and/or 20 seconds/g (s/g).

In other examples, the films of the present invention have a per sample less than 1000 seconds, and/or less than 900 seconds, and/or less than 800 seconds, and/or as measured according to the dissolution test methods described herein. Alternatively, it exhibits an average degradation time of less than 700 seconds and/or less than 600 seconds and/or less than 500 seconds/g (s/g).

In one example, the film of the present invention has a thickness greater than 0.01 mm and/or greater than 0.05 mm and/or 0.1 mm as measured by the thickness test method described herein. Greater than and/or up to about 20 mm and/or up to about 10 mm and/or up to about 5 mm and/or up to about 2 mm and/or up to 0.5 mm and/or about 0. The thickness may be up to 3 mm.

The filament-forming material is any suitable material, such as a polymer or monomer that can produce a polymer that exhibits properties suitable for making filaments, such as by a spinning process.

In one example, the filament forming material may comprise a polar solvent soluble material, such as an alcohol soluble material and/or a water soluble material.

In other examples, the filament forming material may include a non-polar solvent soluble material.

In yet other embodiments, the filament forming material may include a polar solvent soluble material and may not include a non-polar solvent soluble material (less than 5% by weight and/or 3% by weight on a dry filament basis). Less than and/or less than 1% by weight and/or 0% by weight).

In yet another embodiment, the filament forming material may be a film forming material. In yet other embodiments, the filament-forming material may be synthetic or naturally derived, which may be chemically, enzymatically and/or physically modified.

In yet another embodiment of the invention, the filament forming material is a polymer derived from acrylic monomers such as ethylenically unsaturated carboxylic acid monomers and ethylenically unsaturated monomers, polyvinyl alcohol, polyacrylates, polymethacrylates, Copolymers of acrylic acid and methyl acrylate, polyvinyl pyrrolidone, polyalkylene oxide, starch and starch derivatives, pullulan, gelatin, hydroxylpropyl methylcellulose, methylcellulose, and polymers selected from the group consisting of carboxymethylcellulose may be included.

In yet another embodiment, the filament forming material is polyvinyl alcohol, polyvinyl alcohol derivative, starch, starch derivative, cellulose derivative, hemicellulose, hemicellulose derivative, protein, sodium alginate, hydroxypropylmethylcellulose, chitosan, chitosan derivative, polyethylene glycol, tetra It may include a polymer selected from the group consisting of methylene ether glycol, polyvinyl pyrrolidone, hydroxymethyl cellulose, hydroxyethyl cellulose, and mixtures thereof.

In a further embodiment, the filament-forming material comprises pullulan, hydroxypropylmethylcellulose, hydroxyethylcellulose, hydroxypropylcellulose, polyvinylpyrrolidone, carboxymethylcellulose, sodium alginate, xanthan gum, tragacanth gum, guar gum, acacia gum, gum arabic, polyacrylic acid, methyl Methacrylate copolymer, carboxyvinyl polymer, dextrin, pectin, chitin, levan, erucinane, collagen, gelatin, zein, gluten, soy protein, casein, polyvinyl alcohol, starch, starch derivative, hemicellulose, hemicellulose derivative, protein, chitosan, chitosan derivative, Polyethylene glycol, tetramethylene ether glycol, Mud carboxymethylcellulose, and comprises a polymer selected from the group consisting of mixtures.

Polar solvent-soluble materials Non-limiting examples of polar solvent-soluble materials include polar solvent-soluble polymers. The polar solvent soluble polymer may be synthetic or naturally derived and may be chemically and/or physically modified. In one example, the polar solvent soluble polymer is at least about 10,000 g/mol, and/or at least about 20,000 g/mol, and/or at least 40,000 g/mol, and/or at least 80,000 g/mol, And/or at least about 100,000 g/mol, and/or at least 1,000,000 g/mol, and/or at least 3,000,000 g/mol, and/or at least 10,000,000 g/mol, and/or It exhibits a weight average molecular weight of at least 20,000,000 g/mol and/or up to about 40,000,000 g/mol and/or up to about 30,000,000 g/mol.

In one example, the polar solvent soluble polymer is selected from the group consisting of alcohol soluble polymers, water soluble polymers, and mixtures thereof. Non-limiting examples of water soluble polymers include water soluble hydroxyl polymers, water soluble thermoplastic polymers, water soluble degradable polymers, water soluble non biodegradable polymers, and mixtures thereof. In one example, the water soluble polymer comprises polyvinyl alcohol. In other examples, the water soluble polymer comprises starch. In yet another embodiment, the water soluble polymer comprises polyvinyl alcohol and starch.

In one example, the solvent consists of a water-soluble hydroxyl polymers according to the present invention include polyols such as polyvinyl alcohol, polyvinyl alcohol derivatives, polyvinyl alcohol copolymers, starch, starch derivatives, starch copolymers, chitosan, chitosan derivatives, Chitosan copolymers, cellulose, cellulose derivatives, such as cellulose ether and ester derivatives, cellulose copolymers, hemicellulose, hemicellulose derivatives, hemicellulose copolymers, gums, arabinans, galactants, proteins and various other polysaccharides, and mixtures thereof.

In one embodiment, the water soluble hydroxyl polymer of the present invention comprises a polysaccharide.

As used herein, “polysaccharide” means natural polysaccharides and polysaccharide derivatives or modified polysaccharides. Suitable water soluble polysaccharides include, but are not limited to starch, starch derivatives, chitosan, chitosan derivatives, cellulose derivatives, hemicellulose, hemicellulose derivatives, gums, arabinans, galactans, and mixtures thereof. The water-soluble polysaccharide is from about 10,000 g/mole to about 40,000,000 g/mole and/or more than 100,000 g/mole and/or more than 1,000,000 g/mole. Alternatively, it may exhibit a weight average molecular weight of greater than 3,000,000 g/mol and/or greater than about 3,000,000 g/mol and up to about 40,000,000 g/mol.

The water-soluble polysaccharide may comprise non-cellulose and/or non-cellulose derivatives and/or non-cellulose copolymer water-soluble polysaccharides. Such non-cellulose soluble polysaccharides may be selected from the group consisting of starch, starch derivatives, chitosan, chitosan derivatives, hemicellulose derivatives, hemicellulose derivatives, gums, arabinans, galactans, and mixtures thereof.

In another embodiment, the water soluble hydroxyl polymer of the present invention comprises a non-thermoplastic polymer.

The water-soluble hydroxyl polymer can be from about 10,000 g/mol to about 40,000,000 g/mol, and/or more than 100,000 g/mol, and/or more than 1,000,000 g/mol, and/or Alternatively, it may exhibit a weight average molecular weight of greater than 3,000,000 g/mol and/or greater than about 3,000,000 g/mol and up to about 40,000,000 g/mol. Higher and lower molecular weight water-soluble hydroxyl polymers may be used in conjunction with hydroxyl polymers having a weight average molecular weight within a particular desired range.

Well known modifications of water soluble hydroxyl polymers such as natural starch include chemical and/or enzymatic modifications. For example, native starch can be acid-thinned, hydroxyethylated, hydroxypropylated, and/or oxidized. Further, the water soluble hydroxyl polymer may comprise dent corn starch.

Naturally occurring starch is generally a mixture of linear amylose and branched amylopectin polymers of D glucose units. Amylose is essentially a linear polymer of D-glucose linked by (1,4)-α-D bonds. Aminopectin is a highly branched polymer of (1,4)-α-D bonds and (1,6)-α-D-glucose units at branch points. Naturally occurring starch is typically a relatively high concentration of amylopectin, such as corn starch (64-80% amylopectin), waxy maize (93-100% amylopectin), rice (83-84% amylopectin), potato (About 78% amylopectin) and wheat (73-83% amylopectin). Although all starches are potentially useful herein, the present invention is most commonly practiced with high amylopectin natural starch derived from agricultural sources, which is an abundant source and can be easily supplemented And offers the advantage of being inexpensive.

As used herein, “starch” includes any naturally occurring unmodified starch, modified starch, synthetic starch, and mixtures thereof, and mixtures of amylose or amylopectin fractions, It may be modified by chemical, chemical, or biological processes, or combinations thereof. In the context of the present invention, the unmodified or modified starch may depend on the desired end product. In one embodiment of the present invention, the starch or starch mixture useful in the present invention is from about 20% to about 100%, more typically from about 40% to about 90%, even more typically. Having an amylopectin content from about 60 wt % to about 85 wt % starch or mixtures thereof.

Suitable starches of natural origin include: corn starch, potato starch, sweet potato starch, wheat starch, sago palm starch, tapioca starch, rice starch, soybean starch, arrow root starch, amioca starch, bracken starch, lotus starch, Non-limiting examples include waxy corn starch and high amylose corn starch. Naturally occurring starches, particularly corn starch and wheat starch, are preferred starch polymers due to their economics and availability.

The polyvinyl alcohol herein can be grafted with other monomers to improve its properties. A wide range of monomers have been successfully grafted to polyvinyl alcohol. Non-limiting examples of such monomers include vinyl acetate, styrene, acrylamide, acrylic acid, 2-hydroxyethyl methacrylate, acrylonitrile, 1,3-butadiene, methyl methacrylate, methacrylic acid, maleic acid, itaconic acid, vinyl sulfonic acid. Sodium, sodium allyl sulfonate, sodium methyl allyl sulfonate, sodium phenyl allyl ether sulfonate, sodium phenyl methallyl ether sulfonate, 2-acrylamido-methyl propane sulfonic acid (AMPs), vinylidene chloride, vinyl chloride, vinyl amine, and various Examples include acrylate esters.

In one example, the water soluble hydroxyl polymer is selected from the group consisting of polyvinyl alcohol, hydroxymethylcellulose, hydroxyethylcellulose, hydroxypropylmethylcellulose, and mixtures thereof. Non-limiting examples of suitable polyvinyl alcohols include those commercially available from Sekisui Specialty Chemicals America, LLC (Dallas, TX) under the trade name CELVOL®. Non-limiting examples of suitable hydroxypropyl methylcellulose include those commercially available from Dow Chemical Company (Midland, MI) under the trademark METHOCEL®, including combinations with the hydroxypropyl methylcellulose described above.

In yet another example, the water-soluble thermoplastic polymers consists of examples of suitable water-soluble thermoplastic polymers include thermoplastic starch and/or starch derivatives, polylactic acid, polyhydroxyalkanoates, polycaprolactones, polyester amides, and certain polyesters As well as mixtures thereof.

The water-soluble thermoplastic polymer of the present invention may be hydrophilic or hydrophobic. The water soluble thermoplastic polymer may be surface treated and/or internally treated to alter the hydrophilic or hydrophobic properties inherent in the thermoplastic polymer.

The water soluble thermoplastic polymer may comprise a biodegradable polymer.

Any suitable weight average molecular weight may be used for the thermoplastic polymer. For example, the weight average molecular weight of the thermoplastic polymer according to the present invention is greater than about 10,000 g/mole and/or greater than about 40,000 g/mole and/or greater than about 50,000 g/mole. And/or less than about 500,000 g/mole and/or less than about 400,000 g/mole and/or less than about 200,000 g/mole.

Non-polar solvent soluble material Non-limiting examples of non-polar solvent soluble materials include non-polar solvent soluble polymers. Non-limiting examples of suitable non-polar solvent soluble materials include cellulose, chitin, chitin derivatives, polyolefins, polyesters, copolymers thereof, and mixtures thereof. Non-limiting examples of polyolefins include polypropylene, polyethylene, and mixtures thereof. Non-limiting examples of polyesters include polyethylene terephthalate.

Nonpolar solvent soluble materials may include non-biodegradable polymers such as polypropylene, polyethylene, and certain polyesters.

Any suitable weight average molecular weight may be used for the thermoplastic polymer. For example, the weight average molecular weight of the thermoplastic polymer according to the present invention is greater than about 10,000 g/mole and/or greater than about 40,000 g/mole and/or greater than about 50,000 g/mole. And/or less than about 500,000 g/mole and/or less than about 400,000 g/mole and/or less than about 200,000 g/mole.

Activators are a class of additives designed and intended to benefit something other than the filament itself, for example, benefiting the environment outside the filament. The active agent may be any suitable additive that produces the intended effect under the intended use of the filament. For example, the active agent may be a personal cleansing and/or conditioning agent such as a hair care agent such as a shampoo and/or hair dye agent, a hair conditioning agent, a skin care agent, a sunscreen agent, and a skin conditioning agent; laundry care and/or conditioning Agents, such as fabric care agents, fabric conditioning agents, fabric softeners, fabric anti-wrinkle agents, fabric care antistatic agents, fabric care stain removers, soil release agents, dispersants, foam inhibitors, foaming agents, antifoaming agents, And fabric refreshing agents; hard surface care and/or conditioning agents, eg liquid and/or powder dishwashing agents (for dishwashing and/or automatic dishwashing for hand washing), and abrasives; other cleaning and And/or conditioning agents such as antibacterial agents, perfumes, bleaches (eg oxygen bleaching), Hydrogen peroxide, percarbonate bleach, perborate bleach, chlorine bleach), bleach activator, chelating agent, builder, lotion, whitening agent, air care agent, carpet care agent, dye transfer inhibitor, Water softener, water softener, pH adjuster, enzyme, flocculant, foaming agent, preservative, cosmetic agent, makeup remover, foaming agent, adhesion aid, coacervate forming material, clay, thickener, latex, Silica, desiccant, odor inhibitor, antiperspirant, cooling agent, warming agent, absorbent gel, anti-inflammatory agent, dye, pigment, acid and base; liquid treatment active agent; agricultural active agent, industrial active agent, ingestion Possible active agents such as drugs, tooth whitening agents, tooth care agents, mouthwashes, periodontal gum care agents, edible agents, edible agents, vitamins, minerals, water treatment agents such as water purification and/or water disinfectants Selected from the group consisting of It may be.

Non-limiting examples of suitable cosmetics, skin care agents, skin conditioning agents, hair care agents, and hair conditioning agents can be found in “CTFA Cosmetic Ingredient Handbook” (Second Edition, The Cosmetics, Toiletries, and Fragrance Assoc. 8 1992).

One or more classes of chemicals may be useful for one or more of the active agents listed above. For example, a surfactant active may be useful for any number of the active agents described above. Similarly, bleach can be used in fabric care, hard surface cleaning, dishwashing, and even tooth whitening. Thus, those skilled in the art will appreciate that the active agent is selected based on the desired intended use of the filament and/or the nonwoven fabric made therefrom.

For example, the filaments of the present invention and/or nonwovens made therefrom should be used for hair care and/or conditioning thereof, whereby one or more surfactants, such as foamable surfactants, Filaments and/or non-woven fabrics incorporating filaments can be selected to provide the desired benefits to the consumer when exposed to the intended application conditions.

In one example, the filaments of the invention and/or nonwovens made therefrom are designed or intended for use in laundry of clothes in a laundry operation, and then one or more suitable surfactants, and Enzymes, and/or builders, and/or fragrances, and/or foam suppressors, and/or bleaching agents are desired when exposed to the intended use conditions of the filaments and/or nonwovens incorporating the filaments. Can be chosen to provide consumers with the benefits. In another embodiment, the filaments of the invention and/or nonwovens made therefrom are designed to be used in exterior or interior car washing operations, where the filaments are then washed a detergent composition may be included.

As used herein “surfactants” includes non-limiting examples of suitable surfactants include anionic surfactants, cationic surfactants, nonionic surfactants, zwitterionic surfactants, and amphoteric surfactants. A co-surfactant may also be included in the filament. For example, for filaments designed for use as laundry detergents and/or dishwashing agents, the total surfactant concentration should be sufficient to provide cleaning including stain and/or odor removal. Generally in the range of about 0.5% to about 95%. In addition, surfactant systems comprising two or more surfactants designed for use in laundry detergent and/or dishwashing filaments are fully anionic surfactant systems, anionic and A mixture type surfactant system comprising a mixture of nonionic surfactants, or a mixture of nonionic-cationic surfactants may be included.

Surfactants may be linear or branched herein. In one embodiment, suitable linear surfactants include those derived from agricultural chemical oils, such as coconut oil, palm kernel oil, soybean oil, or other vegetable oils.

As used herein “anionic surfactants” includes non-limiting examples of suitable anionic surfactants include alkyl sulfates, alkyl ether sulfates, branched alkyl sulfates, branched alkyl alkoxylates, branched alkoxylate sulfates, medium Chain branched alkyl allyl sulfonate, sulfated monoglyceride, sulfonated olefin, alkyl allyl sulfonate, primary or secondary alkane sulfonate, alkyl sulfosuccinate, acyl taurate, acyl isethionate, alkyl glyceryl ether sulfonate, Sulfonated methyl ester, sulfonated fatty acid, alkyl phosphate, acyl glutamate, acrylic sarcosinate, alkyl sulfoacetate, acylated peptide, alkyl ether carboxylate, acyl. Examples include rulactylate, anionic fluorosurfactants, sodium lauroyl glutamate, and combinations thereof.

Suitable alkyl sulfates and alkyl ether sulfates for use herein include materials having the corresponding formulas ROSO₃M and RO(C₂H₄O)ₓSO₃M, wherein R Is an alkyl or alkenyl from about 8 to about 24 carbon atoms, x is 1-10, and M is a water-soluble cation such as ammonium, sodium, potassium, and triethanolamine. Other suitable anionic surfactants are MacCutcheon's “Detergents and Emulsifiers” (North American Edition (1986), Allred Publishing Corp.) and McCutcheon's “Functional Materials 92” (Natural Publishing Corp.).) It is described in.

In one embodiment, anionic surfactants useful in the filaments of the present invention, C₉-C₁₅ alkyl benzene sulfonates (LAS), C₈-C₂₀ alkyl ether sulfates, such as alkyl poly (ethoxy) sulfates, C₈˜C₂₀ alkyl sulfates, and mixtures thereof. Other anionic surfactants include methyl ester sulfonate (MES), methyl ester etchelate (MEE), sulfonated estolides, and mixtures thereof.

In other examples, the anionic surfactant is a C₁₁-C₁₈ alkyl benzene sulfonate (“LAS”) and primary branched chain, and a random C₁₀-C₂₀ alkyl sulfate (“AS”), formula CH₃(CH₂)x(CHOSO₃-M+) CH 3 and CH₃(CH₂)y(CHOSO₃-M+) C10˜C18 secondary of CH₂CH 3 (2,3) alkyl sulfates (formula In which x and (y+1) are integers of at least about 7, preferably about 9, and M is a water-solubilizing cation, in particular sodium, an unsaturated sulfate such as oleyl sulfate), C₁₀-C₁₈ α-sulfonated fatty acid esters, C₁₀-C₁₈ sulfated alkyl polyglycosides, C₁₀-C₁₈ alkyl alkoxy sulfates (“AEₓ S”) (the formula x is 1 to 30), and C₁₀-C₁₈ alkyl alkoxy Ruboxylates (eg containing 1-5 ethoxy units), medium chain branched alkyl sulfates as described in U.S. Pat. Nos. 6,020,303 and 6,060,443; US Pat. No. 6,008, Medium chain branched alkyl alkoxy sulfates (MLAS) as described in 181 and 6,020,303; as described in WO 99/05243, WO 99/05242, and WO 99/05244 Modified alkylbenzene sulfonate (MILAS); methyl ester sulfonate (MES); and alpha-olefin sulfonate (AOS).

Other suitable anionic surfactants that can be used are alkyl ester sulfonate surfactants, including sulfonated linear esters of C₈ to C₂₀ carboxylic acids (ie fatty acids). The Other suitable anionic surfactants that can be used salts of soap, C₈-C₂₂ primary or secondary alkane sulfonates (primary of secondary alkanesulfonates), C₈-C₂₄ olefin sulfonates, sulfonated polycarboxylic acids, C₈-C₂₄ alkyl polyglycol ether sulfates (alkylpolyglycolethersulfates) (contain ethylene oxide up to 10 moles); alkyl glycerol sulfonates, fatty acyl glycerol sulfonates, fatty oleoyl glycerol sulfates, alkyl phenol ethylene oxide ether sulfates, paraffin sulfonates, alkyl phosphates, Isethinates, eg acyl isethionates, N-acyl taurates, alkyl succinates and sulfosuccinates, monoesters of sulfosuccinates (E.g. saturated and unsaturated C₁₂-C₁₈ monoesters) monoester, diester sulfosuccinates (e.g., saturated and unsaturated C₆-C₁₂ diesters), and alkyl polysaccharide sulfates, such as alkyl polysaccharides sulfates, and alkyl polyethoxy carboxylates such as those of the formula RO(CH₂CH₂O)k-CH 2 COO-M+ (wherein R is a C₈-C₂₂ alkyl, k is an integer of 0, M is a soluble salt-forming cation).

Other exemplary anionic surfactants are alkyl benzene sulphonic acid of C₁₀-C₁₆, preferably an alkali metal salt of alkylbenzene sulfonic acid C₁₁-C₁₄. In one embodiment, the alkyl group is linear. Such linear alkyl benzene sulfonates are known as “LAS”. Such surfactants and their preparation are described, for example, in U.S. Pat. Nos. 2,220,099 and 2,477,383.

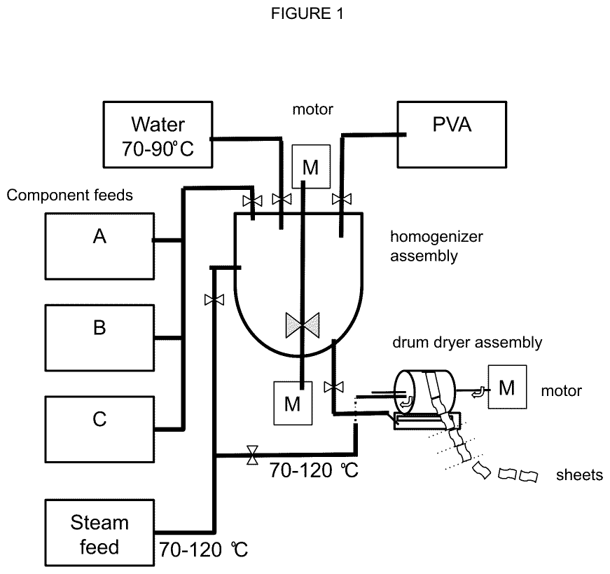

Referring now to the FIGURES, FIG. 1 is an illustration of a non-limiting embodiment of a homogenizer assembly, component feeds, and drum dryer assembly according to the invention. FIG. 1 shows water supply at 70-90° C. for delivery to the homogenizer tank via pumped delivery pipe with a control valve. The homogenizer tank includes a mixing paddle connected to electric motors. The PVA supply delivers polyvinyl alcohol to the homogenizer tank via pumped or gravity fed conduit for dissolving in the water. Component feeds A, B, C are delivered via pumped conduit to the homogenizer tank, and steam feed 70-120° C.

In the present invention the polyvinyl alcohol, water, a surfactant, a builder, a binding agent, a chelating agent, and a car surface treatment ingredient, form a PVA homogenate by mixing in a single homogenizer tank, and the homogenizer tank is heated using steam.

The PVA paste/homogenate is pumped to the drum dryer assembly and delivered to a bottom feed tray having a bottom feed applicator roller disposed therein. The drum dryer comprises a heated drying drum having a drive system and a mirror finish, said drying drum mounted over a bottom applicator roller assembly having a bottom feed tray with a bottom feed applicator roller disposed therein, the bottom fed tray having a inlet for receiving the paste, the bottom feed applicator roller in operative contact with paste in the bottom feed tray, wherein rotational engagement between the drying drum and the bottom feed applicator roller forms a water dissolvable car cleaning sheet.

FIG. 1 also shows optional the optional step of trimming the water dissolvable car cleaning sheet to a form 1.5-2.0 mm thick, 50-127 mm wide, and 76-203 mm long.

In another non-limiting preferred embodiment, an additional step of surface spraying the water dissolvable car cleaning sheet with a surface agent selected from the group consisting of a bleaching agent, a bleach particle, a pH modifying agent, a bleach activator, a surfactant, a builder, a binding agent, a chelating agent, a fragrance, and a combination of one or more thereof.

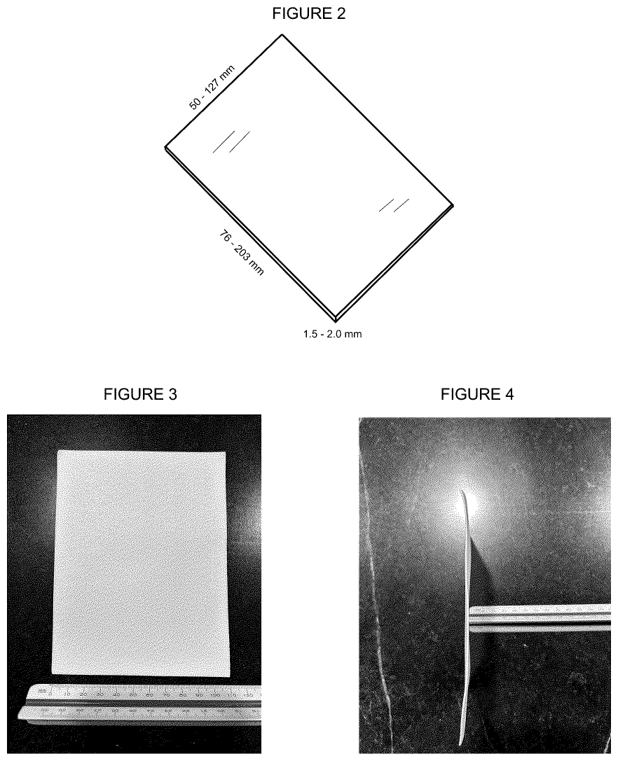

FIG. 2 is an illustration of a non-limiting embodiment in a perspective view showing the dimensions of a water dissolvable PVA sheet according to the invention.

FIG. 3 is a photo representation of a top view of a non-limiting embodiment showing ruler dimensions of a water dissolvable PVA sheet according to the invention.

FIG. 4 is a photo representation of a side view of a non-limiting embodiment showing ruler dimensions of a water dissolvable PVA sheet according to the invention.

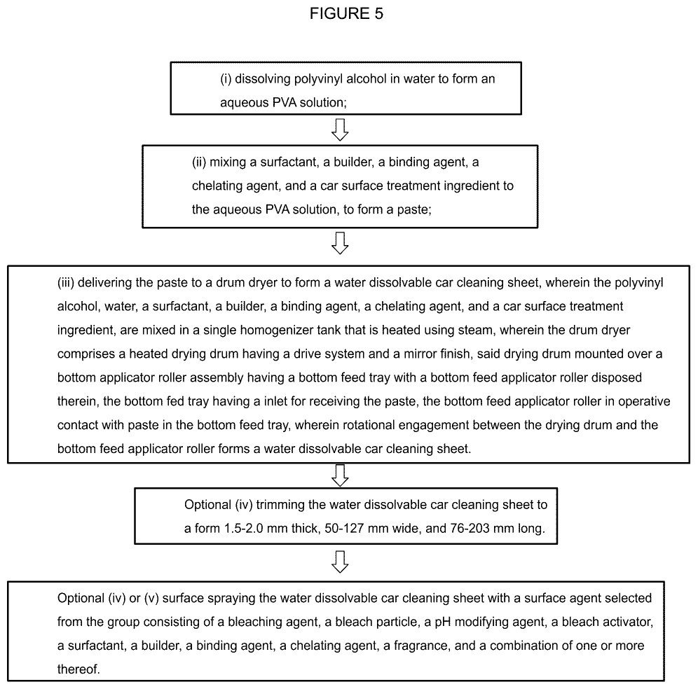

FIG. 5 is a flow chart illustration of a non-limiting embodiment of a method of manufacturing a water dissolvable PVA sheet using a homogenizer assembly, a supply for component feeds, and a drum dryer assembly according to the invention.

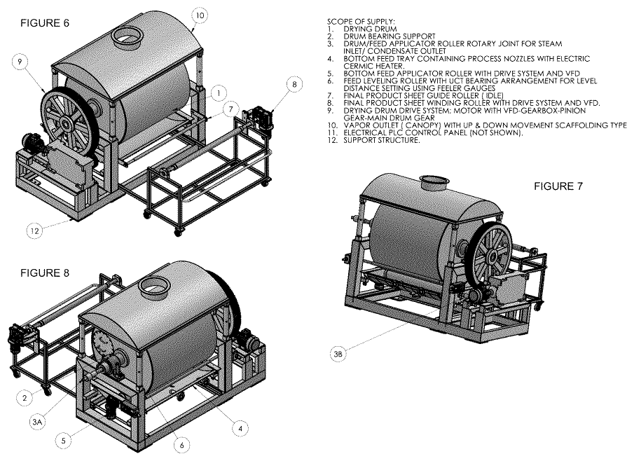

FIG. 6 is a perspective illustration of a non-limiting embodiment of a drum dryer assembly showing a drum drive and a sheet winding assembly. FIG. 6 shows drying drum gear system 9 with a motor having a variable frequency drive (VFD) gearbox pinion gear and main drum gear. FIG. 6 shows vapor outlet in canopy 10 with up/down movement scaffolding. Drying drum 1 is shown over the applicator try and adjacent to the final product sheet guide roller 7. Final product sheet winding roller assembly 8 with drive system and VFD is shown in position to receive the dried sheet.

FIG. 7 is a perspective illustration of a non-limiting embodiment of a drum dryer assembly showing a drum drive. FIG. 7 shows drum/feed applicator roller 3B with a rotary joint for a steam inlet and condensate outlet for the drum.

FIG. 8 is a perspective illustration of a non-limiting embodiment of a drum dryer assembly showing a drum drive and steam inlet. FIG. 8 shows drum bearing support 2. FIG. 8 also shows 3A rotary joint for a steam inlet for the drum. A bottom feed applicator roller 5 is shown having a drive system and VFD. A feed leveling roller 6 with a UCT bearing arrangement for level distance setting using feeler gauges is also shown. Bottom feed tray 4 is shown and contains nozzles with an electric ceramic heater.

FIG. 9 is an side view illustration of a non-limiting embodiment of a drum dryer assembly showing a drum drive, a steam inlet, and applicator roller tray.

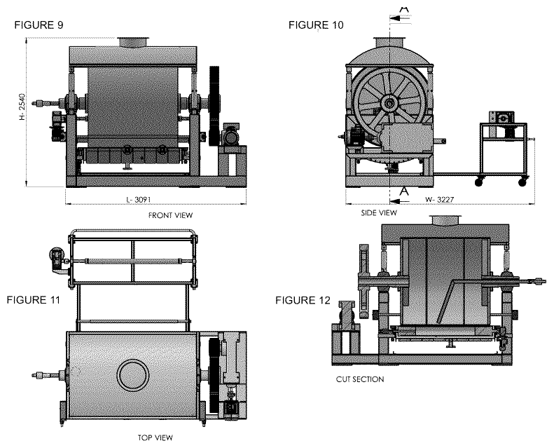

FIG. 10 is an end view illustration of a non-limiting embodiment of a drum dryer assembly showing a drum drive, motor, and sheet winding assembly.

FIG. 11 is a top view illustration of a non-limiting embodiment of a drum dryer assembly showing a drum drive, motor, and sheet winding assembly.

FIG. 12 is a cut-away view illustration of a non-limiting embodiment of a drum dryer assembly showing a drum drive, motor, dryer drum, roller tray, roller, and steam delivery conduit.

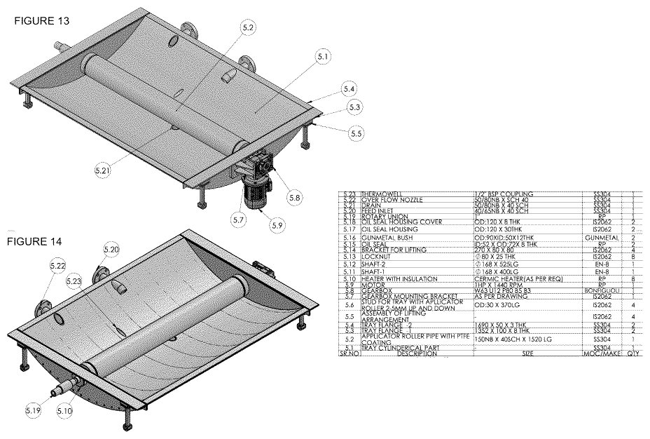

FIG. 13 is an perspective illustration of a non-limiting embodiment of an applicator roller tray, and roller assembly. FIG. 13 shows applicator roller pipe with PFTE coating 5.2 as part of the applicator tray. Drain 5.21 is shown at the bottom of the tray and roller motor is shown with 5.7 gearbox mounting bracket, 5.8 gearbox, and motor 5.9. Assembly lifting mechanism 5.5 is shown mounted on the tray lower surface.

FIG. 14 is an perspective illustration of a non-limiting embodiment of an applicator roller tray, and roller assembly. FIG. 14 shows overflow nozzle 5.22, drain 5.23, and feed inlet 5.20 for paste. Applicator tray also shows a heater unit 5.10.

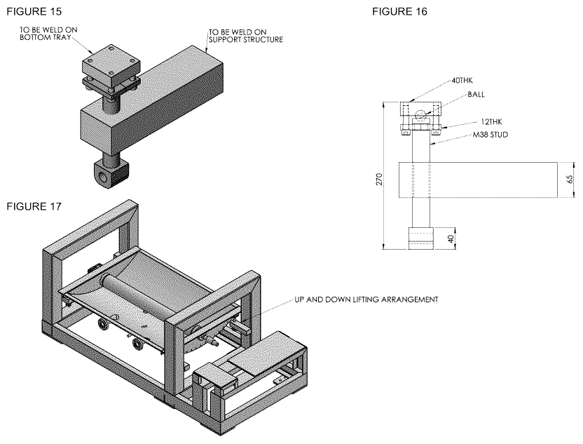

FIG. 15 is an perspective illustration of a non-limiting embodiment of a tray raising/lowering assembly.

FIG. 16 is a side view illustration of a non-limiting embodiment of a tray raising/lowering assembly.

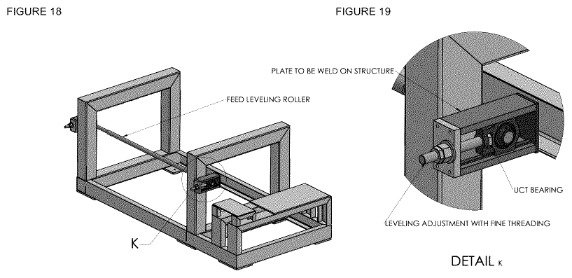

FIG. 17 is an perspective illustration of a non-limiting embodiment of an applicator tray, roller, and tray raising/lowering assembly.

FIG. 18 is an perspective illustration of a non-limiting embodiment of a (sheet) feed leveling roller assembly.

FIG. 19 is a detailed illustration of a non-limiting embodiment of a leveling adjustment mechanism for the (sheet) feed leveling roller assembly.

### Terminology

The terminology used herein is for the purpose of describing particular embodiments only and is not intended to limit the full scope of the claims. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a”, “an” and “the” are intended to include the plural forms as well, unless the context clearly indicates otherwise. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” etc.). Similarly, the terms “comprises” and/or “comprising,” when used in this specification, specify the presence of stated features, integers (or fractions thereof), steps, operations, elements, and/or components, but do not preclude the presence or addition of one or more other features, integers (or fractions thereof), steps, operations, elements, components, and/or groups thereof. As used in this document, the term “comprising” means “including, but not limited to.”

As used herein the term “and/or” includes any and all combinations of one or more of the associated listed items. It should be understood that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All ranges disclosed herein also encompass any and all possible subranges and combinations of subranges thereof unless expressly stated otherwise. Any listed range should be recognized as sufficiently describing and enabling the same range being broken down into at least equal subparts unless expressly stated otherwise. As will be understood by one skilled in the art, a range includes each individual member.

### EQUIVALENTS

Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations.

The embodiments described herein can include various combinations and/or sub-combinations of the functions, components, and/or features of the different embodiments described. Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed as the invention:

1. A process for manufacturing a water dissolvable car cleaning sheet, comprising: (i) homogenizing in a high shear mixer an aqueous solution of polyvinyl alcohol, a surfactant, a builder, a binding agent, a chelating agent, and a car surface treatment ingredient, to form a PVA homogenate; (ii) casting the PVA homogenate as a wet film onto a heated stainless steel roller drum and dehydrating using steam heat to obtain a PVA film 1.5-2.0 mm thick; and (iii) optionally trimming the PVA film to form a single sheet size 50-127 mm wide and 76-203 mm length of a water dissolvable car cleaning sheet.

2. A water dissolvable car cleaning sheet made accord to the process of claim 1, wherein by weight percentage the polyvinyl alcohol is 3-25%, the surfactant is 5-50%, the builder is 0.1-5%, the binding agent is 0.1-5%, the chelating agent is 0.1-5%, the car surface treatment ingredient is 0.1-5%, and the water 3-50%, and wherein the PVA film 1.5-2.0 mm thick is trimmed to form a plurality of single sheets 2-5″ in width and 3-8″ in length.

3. The process according to claim 1, wherein the aqueous solution is 85° C. and dehydrating is at 110° C. using steam heat.

4. The process according to claim 1, wherein the car surface treatment is a car interior cleaning treatment comprising sodium triphosphate, 2-butoxyethanol, and ethyl alcohol.

5. The process according to claim 1, wherein the car surface treatment is a car exterior cleaning treatment comprising dimethicone, citral, polyethylene glycol (PEG-9), and sodium hydroxide.

6. The process according to claim 1, wherein said binding agent is selected from the group consisting of: resin, wax, gum, accroides, candelilla, guar gum, gum Arabic, shellac, tragacanth, and a mixture of one or more thereof.

7. The process according to claim 1, wherein the builder is selected from the group consisting of: citric acid, citrate, sodium carbonate, sodium silicate, polyphosphates, and a mixture of one or more thereof.

8. The process according to claim 1, wherein the chelant is selected from the group consisting of EDTA, MGDA, DTPA, sodium gluconate or a mixture of one or more thereof.

9. The process according to claim 1, wherein the aqueous solution includes a residue remover.

10. The process according to claim 1, wherein said aqueous solution includes a water dissolvable co-polymer selected from the group consisting of ethylene oxide co-polymer, propylene oxide co-polymer, and a combination ethylene oxide-propylene oxide co-polymer.

11. The process according to claim 1, wherein the water dissolvable car cleaning sheet is 3-10% water by weight.

12. The process according to claim 1, wherein the water dissolvable car cleaning sheet comprises 0.5% to 12% of a copolymer by weight.

13. The process according to claim 1, wherein the water dissolvable car cleaning sheet comprises 5% to 50% surfactant by weight, wherein the surfactant is selected from the group consisting of an anionic surfactant, a cationic surfactant, a non-ionic surfactant, and an amphoteric surfactant.

14. The process according to claim 1, wherein the chelating agent is selected from the group of EDTA, MGDA, DTPA, zeolite, phosphonate, citric acid, citrate, and a mixture thereof.

15. The process according to claim 1, comprising the step of applying a water-based fragrance 0.3% by weight to the water dissolvable car cleaning sheet using a sandwich roller.

16. The process according to claim 1, wherein the aqueous solution includes a bleaching agent is selected from the group consisting of calcium hypochlorite, sodium hypochlorite, sodium percarbonate, sodium perborate, sodium persulfate, tetrasodium pyrophosphate, urea peroxide and a combination thereof.

17. The process according to claim 1, wherein the aqueous solution includes a fabric softener agent is selected from the group of quaternary ammonium cations/salts, cetrimonium bromide, quaternary ammonium chloride, polydimethylsiloxane, silicone, and a mixture thereof.

18. The process according to claim 1, wherein water dissolvable car cleaning sheet is a hydrogel comprising at least 50% water by weight.

19. The process according to claim 11, wherein the anionic surfactant is selected from a group consisting of sulfate, sulfonate, sodium dodecylbenzene sulfonate, sodium laureth sulfate, and a combination thereof.

20. The process according to claim 1, wherein the aqueous solution includes an anti-beading compound.

21. The process according to claim 1, wherein the aqueous solution includes a cleaning grit selected from the group consisting of silicate, diatomaceous earth, silica particles, quartz particles, calcite particles, rottenstone, whiting, pumice, volcanic ash, marble particles, feldspar particles, copper particles, polymer particles, and metal particles.

22. A water dissolvable car cleaning sheet made according to the process of claim 1.

23. The water dissolvable car cleaning sheet according to claim 1, wherein the sheet is removably mounted on an applicator unit selected from a cleaning mitt, a cleaning glove, a cleaning sponge, a handheld pad holder, and a long handled pad holder.
